(19) United States
(12) Patent Application Publication
(10) Pub. No.: US 2025/0121240 A1
(43) Pub. Date: Apr. 17, 2025

(54) COMPOSITIONS AND METHODS FOR PFAS DEFLUORINATION

(71) Applicant: The Regents of the University of California, Oakland, CA (US)

(72) Inventors: Jinyong Liu, Riverside, CA (US); Tianchi Liu, Riverside, CA (US)

(21) Appl. No.: 18/912,818

(22) Filed: Oct. 11, 2024

Related U.S. Application Data
(60) Provisional application No. 63/543,654, filed on Oct. 11, 2023.

(51) Int. Cl. A62D 3/34; A62D 101/22; B01J 31/22; B01J 35/45

(52) U.S. Cl. CPC A62D 3/34; B01J 31/2295; B01J 35/45; A62D 2101/22; B01J 2523/27

(57) ABSTRACT

Certain embodiments provide ligand-metal composite materials and compositions that could serve as catalyst-reductive agents to accelerate PFAS compounds defluorination. Certain embodiments provide optionally substituted 2,2′-bipyridine and 1,10-Phenanthroline ligand coordinated zero-valent metal as described herein and their use for defluorinating PFAS compounds.

### CROSS-REFERENCE TO RELATED APPLICATION

This application claims priority to U.S. Provisional Application No. 63/543,654 that was filed on Oct. 11, 2023. The entire content of the application referenced above is hereby incorporated by reference herein.

### GOVERNMENT SUPPORT CLAUSES

This invention was made with government support under 1709719 awarded by the National Science Foundation. The government has certain rights in the invention.

### BACKGROUND

The urgent demand for the degradation of per- and polyfluoroalkyl substances (PFAS) in the global water environment has led to numerous technology solutions in the past few decades. The majority of engineering approaches use energetic inputs such as hydrothermal, ultraviolet light, plasma, electricity, ultrasonication, and even gamma ray to cleave the strong C—F bonds. However, certain PFAS compounds are notoriously refractory to chemical degradation and may require high energy input. Current materials and methods used for PFAS defluorination still have various limitations. New and efficient materials and methods are needed.

### SUMMARY OF THE INVENTION

Certain embodiments of the invention provide a composition comprising:
1) a zero-valent metal selected from the group consisting of Zn, Fe, Al, Ti, and Mg (zinc, iron, aluminum, titanium, and magnesium); and
2) a ligand compound having structure of

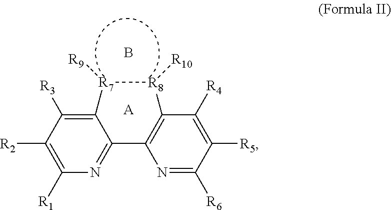

wherein R₁, R₂, R₃, R₄, R₅, and R₆ are each independently H, (C₁-C₆)alkyl, (C₁-C₆)alkoxy, halo, amino, hydroxy, nitro, or CN;
wherein R₇, and R₈ are each independently H, (C₁-C₆)alkyl, (C₁-C₆)alkoxy, halo, amino, hydroxy, nitro or CN, or R₇ and R₈ along with the intervening carbon atoms form a six membered carbocycle ring A;
wherein ring A is absent, or is the six membered carbocycle ring optionally substituted with R₉ and R₁₀, or is the six membered carbocycle ring fused with a six-membered heteroaryl ring B that is optionally substituted with one or more substituent selected from the group consisting of (C₁-C₆)alkyl, (C₁-C₆)alkoxy, halo, amino, hydroxy, nitro, and CN; and wherein R₉, and R₁₀ are each independently absent, (C₁-C₆)alkyl, (C₁-C₆)alkoxy, halo, amino, hydroxy, nitro, oxo (═O), or CN.

Certain embodiments of the invention provide a method as described herein.

Certain embodiments of the invention provide a composite or composition as described herein (e.g., metallic particles, and a ligand).

Certain embodiments of the invention provide a method of making a composition as described herein, comprising mixing the zero-valent metal with the ligand (e.g., in an aqueous solution).

Certain embodiments of the invention provide a method for degrading a PFAS compound, comprising contacting the PFAS compound with a composite or composition as described herein.

Certain embodiments of the invention provide a device or system as described herein (e.g., a filtering device comprising the composition as described herein).

### BRIEF DESCRIPTION OF THE FIGURES

FIGS. 1A-1H. Background information: (FIGS. 1A-1C) Co complex catalysts for reductive defluorination of branched PFAS; (FIG. 1D) a model Co complex synthesized from CoCl₂ and two N,N-bidentate ligands (ref 58); (FIGS. 1E-1F) examples of PFAS structures that could or could not be defluorinated by known Co catalysts (ref. 28); (FIG. 1G) an enzymatic Mo cofactor complex and (FIG. 1H) an artificial Mo complex synthesized from the (NH₂)₂bpy ligand for perchlorate reduction (ref. 50).

FIGS. 2A-2F. (FIG. 2A) Defluorination of PF-3,7-Me₂OA (0.1 mM) at pH 9.0. Reaction conditions for the Zn⁰ system: Me₂bpy (0.25 mM), nZn⁰ (12.5 mg mL⁻¹), NH₄Cl buffer (10 mM), 70° C. The “optimized” condition used 0.025 mM of Me₂bpy and 10 mg mL⁻¹ of nZn⁰ at 90° C. Reaction conditions for the Co-catalyzed systems (data reproduced from ref. 28): B₁₂ or protoporphyrin-Co (CoPP) (0.25 mM), Ti^{III}-citrate (36 mM), carbonate buffer (40 mM), 70° C.; (FIG. 2B) defluorination of linear PFCAs with Me₂bpy (0.025 mM), nZn⁰ (10 mg mL⁻¹), NH₄Cl (10 mM), 90° C.; (FIG. 2C) C—F bond dissociation energies of PFAS containing eight fluorinated carbons (data reproduced from ref. 67); (FIG. 2D-2F) defluorination of Clₓ—PFCAs at the “optimized” condition unless specified (L=Me₂bpy); all three panels share the same legend.

FIG. 3. Comparison of deF % from various PFAS by Me₂bpy-Zn⁰ and UV/sulfite reported earlier (refs. 66 and 68). Corresponding PFAS structures are shown in Table 2. Each left column is Me₂bpy-Zn⁰ at conditions as shown, and each right column is UV/sulfite at conditions as shown.

FIGS. 4A-4D. Optimization of reaction regarding: (FIG. 4A) the amount of nZn⁰ in batch reactions; (FIG. 4B) ligand ((Me)₂bpy) concentrations at optimized nZn⁰ (10 mg/mL); (FIG. 4C) temperature at optimized nZn⁰ (10 mg/mL) and (Me)₂bpy (0.025 mM); (FIG. 4D) initial pH (10 mg/mL) at (Me)₂bpy (0.025 mM), and temperature (90° C.) in stirring reactions, 4 h. Default reaction conditions: PFMe₂OA (0.1 mM), NH₄Cl (10 mM), stirring.

FIGS. 5A-5B. nZn⁰ powder scanning transmission electron microscope (STEM) images: (FIG. 5A) nZn⁰ powder image with scale bar 500 nm and (FIG. 5B) nZn⁰ powder image with scale bar 20 nm.

### DETAILED DESCRIPTION

New composite, composition, device, system, and/or methods are described herein for PFAS defluorination. It was surprisingly shown herein that organic ligands surprisingly led to reductive defluorination from per- and polyfluoroalkyl substances (PFAS) compounds, including linear Perfluoroalkyl carboxylic acids (PFCAs) and Perfluoroalkyl ether carboxylic acids (PFECAs), by zero valent metal as described herein.

Certain embodiments of the composite, composition, device, system, and methods can be used for in-situ remediation of soil and groundwater from PFAS contamination. For illustrative purposes, the materials and compositions described herein may be used in a permeable reactive barrier installed underground for groundwater remediation. Exemplary application also includes expansion to filter systems for treating water and wastewater streams that contain PFAS. For example, the composite described herein (e.g., Ligand-Zinc composite) can be loaded in the filter system for proactive treatment.

Accordingly, certain embodiments of the invention provide a composition comprising:
1) a zero-valent metal selected from the group consisting of Zn, Fe, Al, Ti, and Mg (zinc, iron, aluminum, titanium, and magnesium); and
2) a ligand compound having structure of

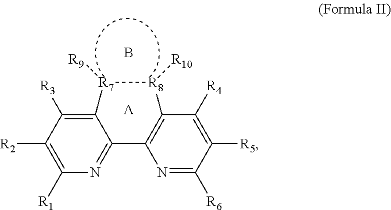

wherein R₁, R₂, R₃, R₄, R₅, and R₆ are each independently H, (C₁-C₆)alkyl, (C₁-C₆)alkoxy, halo, amino, hydroxy, nitro, or CN;
wherein R₇, and R₈ are each independently H, (C₁-C₆)alkyl, (C₁-C₆)alkoxy, halo, amino, hydroxy, nitro or CN, or R₇ and R₈ along with the intervening carbon atoms form a six membered carbocycle ring A;
wherein ring A is absent, or is the six membered carbocycle ring optionally substituted with R₉ and R₁₀, or is the six membered carbocycle ring fused with a six-membered heteroaryl ring B that is optionally substituted with one or more substituent selected from the group consisting of (C₁-C₆)alkyl, (C₁-C₆)alkoxy, halo, amino, hydroxy, nitro, and CN; and
wherein R₉, and R₁₀ are each independently absent, (C₁-C₆)alkyl, (C₁-C₆)alkoxy, halo, amino, hydroxy, nitro, oxo (═O), or CN.

In certain embodiments, R₉, and R₁₀ are oxo (═O).

In certain embodiments, the ring A is absent.

For example, in certain embodiments, the composition comprises:
1) a zero-valent metal selected from the group consisting of Zn, Fe, Al, Ti, and Mg (zinc, iron, aluminum, titanium, and magnesium); and
2) a ligand compound that is 2,2′-bipyridine optionally substituted with one or more (e.g., 1, 2, 3, 4 substituents) substituent selected from the group consisting of (C₁-C₆)alkyl, (C₁-C₆)alkoxy, halo, amino, hydroxy, nitro, and CN.

In certain embodiments, the ligand compound has structure of

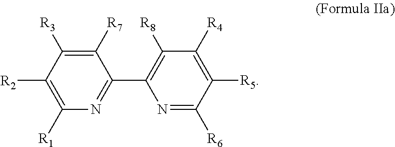

In certain embodiments, R₁, R₂, R₃, R₄, R₅, R₆, R₇, and R₈ are each independently H, (C₁-C₆)alkyl, (C₁-C₆)alkoxy, halo, amino, hydroxy, nitro, or CN.

In certain embodiments, R₁, R₂, R₃, R₄, R₅, R₆, R₇, and R₈ are each independently H, (C₁-C₄)alkyl, (C₁-C₃)alkoxy, halo, amino, hydroxy, nitro, or CN.

In certain embodiments, R₁, R₂, R₃, R₄, R₅, R₆, R₇, and R₈ are each independently H, (C₁-C₃)alkyl, (C₁-C₃)alkoxy, halo, amino, hydroxy, nitro, or CN.

In certain embodiments, R₁, R₂, R₃, R₄, R₅, R₆, R₇, and R₈ are each independently H, (C₁-C₄)alkyl, halo, amino, or CN.

In certain embodiments, R₁, R₂, R₃, R₄, R₅, R₆, R₇, and R₈ are each independently H, (C₁-C₃)alkyl, halo, amino, or CN.

In certain embodiments, R₁, R₂, R₃, R₄, R₅, R₆, R₇, and R₈ are each independently H, methyl, halo (e.g., Cl), or CN.

In certain embodiments, the ring A is a six membered carbocycle ring that is optionally substituted with R₉ and R₁₀.

For example, in certain embodiments, the ligand compound has structure of

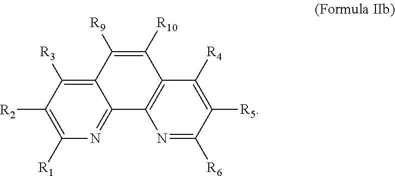

In certain embodiments, R₁, R₂, R₃, R₄, R₅, R₆, R₉, and R₁₀ are each independently H, (C₁-C₆)alkyl, (C₁-C₆)alkoxy, halo, amino, hydroxy, nitro, or CN.

In certain embodiments, R₁, R₂, R₃, R₄, R₅, R₆, R₉, and R₁₀ are each independently H, (C₁-C₄)alkyl, (C₁-C₃)alkoxy, halo, amino, hydroxy, nitro, or CN.

In certain embodiments, R₁, R₂, R₃, R₄, R₅, R₆, R₉, and R₁₀ are each independently H, (C₁-C₃)alkyl, (C₁-C₃)alkoxy, halo, amino, hydroxy, nitro, or CN.

In certain embodiments, R₁, R₂, R₃, R₄, R₅, R₆, R₉, and R₁₀ are each independently H, (C₁-C₄)alkyl, halo, amino, or CN.

In certain embodiments, R₁, R₂, R₃, R₄, R₅, R₆, R₉, and R₁₀ are each independently H, (C₁-C₃)alkyl, halo, amino, or CN.

In certain embodiments, R₁, R₂, R₃, R₄, R₅, R₆, R₉, and R₁₀ are each independently H, methyl, or halo (e.g., Cl).

In certain embodiments, R₉, and R₁₀ are absent, the ring A is a six membered carbocycle ring fused (at R₇ and R₈ position) with a six-membered heteroaryl ring B, and ring B is optionally substituted with one or more substituent selected from the group consisting of (C₁-C₆)alkyl, (C₁-C₆)alkoxy, halo, amino, hydroxy, nitro, and CN.

In certain embodiments, the ligand compound has structure of

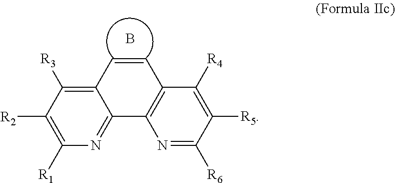

In certain embodiments, the six-membered heteroaryl ring B is a pyrazine ring, that is fused to carbocycle ring A (at R₇ and R₈ position).

In certain embodiments, the six-membered heteroaryl ring B is a pyrazine ring substituted with one or more substituent selected from the group consisting of (C₁-C₆)alkyl, (C₁-C₆)alkoxy, halo, amino, hydroxy, nitro, and CN.

In certain embodiments, R₁, R₂, R₃, R₄, R₅, and R₆, are each independently H, (C₁-C₆)alkyl, (C₁-C₆)alkoxy, halo, amino, hydroxy, nitro, or CN.

In certain embodiments, R₁, R₂, R₃, R₄, R₅, and R₆, are each independently H, (C₁-C₄)alkyl, (C₁-C₃)alkoxy, halo, amino, hydroxy, nitro, or CN.

In certain embodiments, R₁, R₂, R₃, R₄, R₅, and R₆, are each independently H, (C₁-C₃)alkyl, (C₁-C₃)alkoxy, halo, amino, hydroxy, nitro, or CN.

In certain embodiments, R₁, R₂, R₃, R₄, R₅, and R₆, are each independently H, (C₁-C₄)alkyl, halo, amino, or CN.

In certain embodiments, R₁, R₂, R₃, R₄, R₅, and R₆, are each independently H, (C₁-C₃)alkyl, halo, amino, or CN.

In certain embodiments, R₁, R₂, R₃, R₄, R₅, and R₆, are each independently H, methyl, halo (e.g., Cl), or CN.

In certain embodiments, the ligand compound is selected from the group consisting of

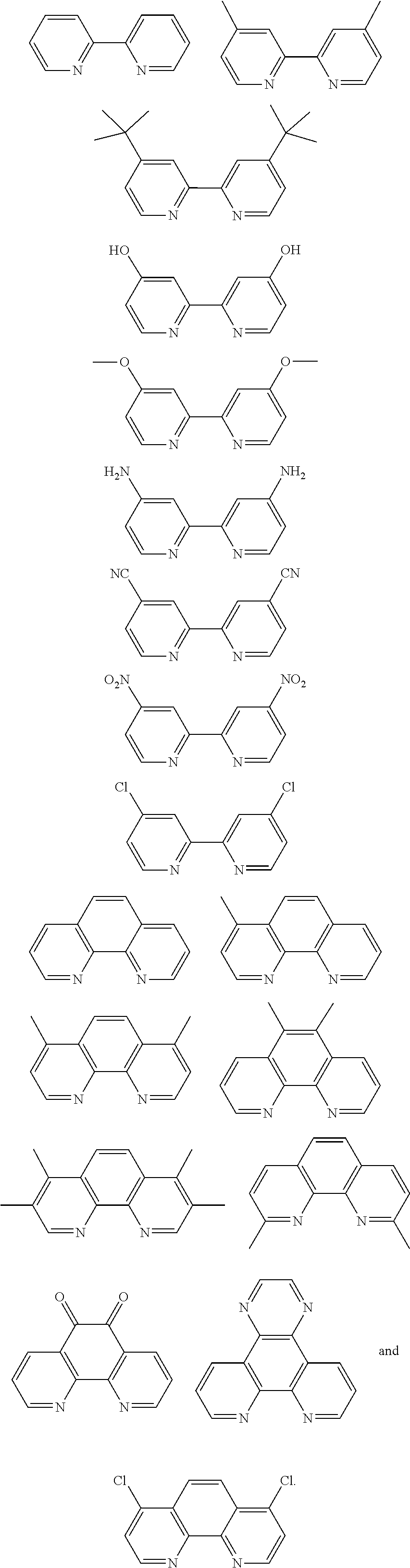

In certain embodiments, the ligand compound has structure of

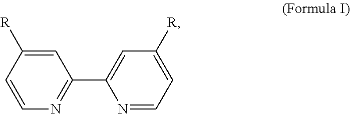

wherein each R is independently H, (C₁-C₆)alkyl, (C₁-C₆)alkoxy, halo, amino, hydroxy, nitro, or CN.

A specific value of R is H, or methyl.

A specific value of R is CN.

A specific value of R is halo (e.g., Cl).

A specific value of R is t-butyl.

A specific value of R is methoxy.

A specific value of R is amino or nitro group.

In certain embodiments, each R is independently H, (C₁-C₄)alkyl, (C₁-C₃)alkoxy, halo, amino, hydroxy, nitro, or CN.

In certain embodiments, each R is independently H, (C₁-C₃)alkyl, (C₁-C₃)alkoxy, halo, amino, hydroxy, nitro, or CN.

In certain embodiments, each R is independently H, (C₁-C₄)alkyl, halo, amino, or CN.

In certain embodiments, each R is independently H, (C₁-C₃)alkyl, halo, amino, or CN.

In certain embodiments, the ligand compound is selected from the group consisting of

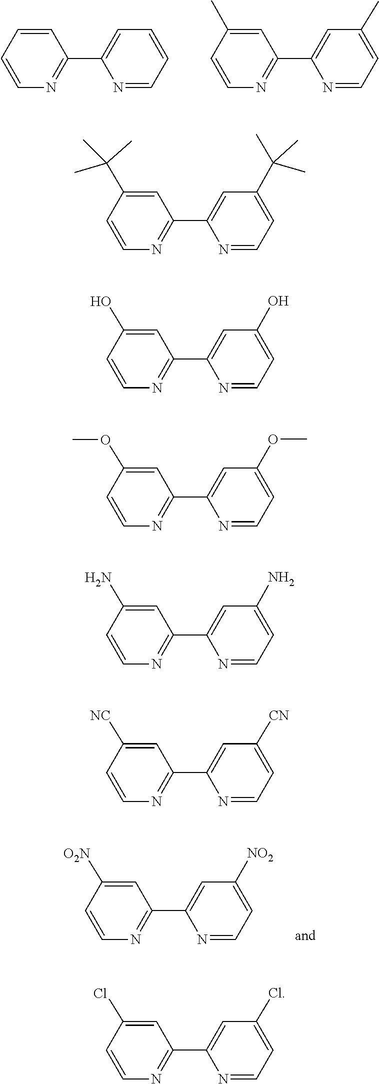

In certain embodiments, the ligand compound is selected from the group consisting of

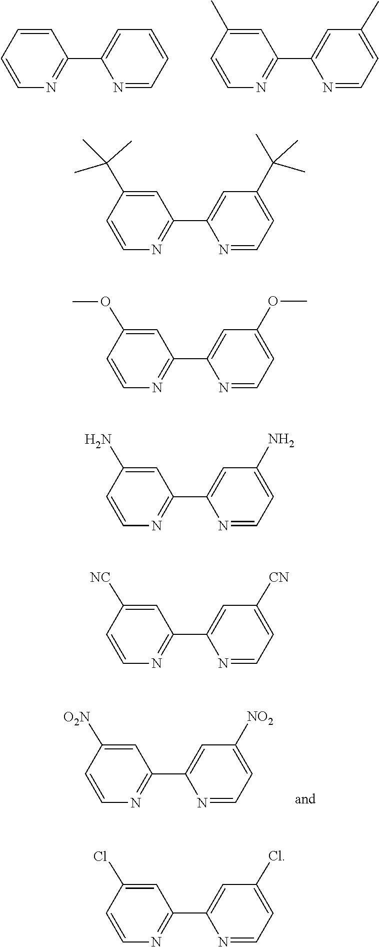

In certain embodiments, the ligand compound is selected from the group consisting of

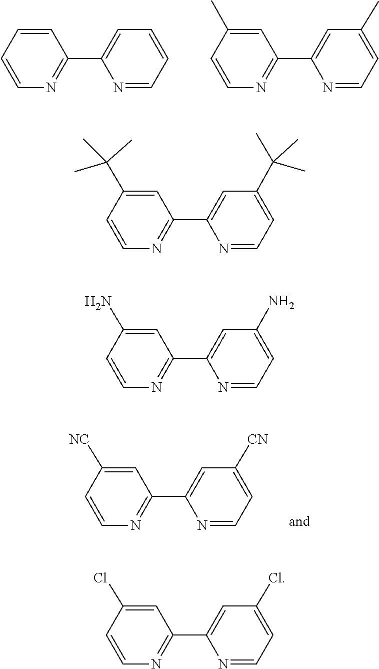

In certain embodiments, the ligand compound is

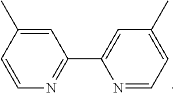

In certain embodiments, the ligand compound is selected from the group consisting of

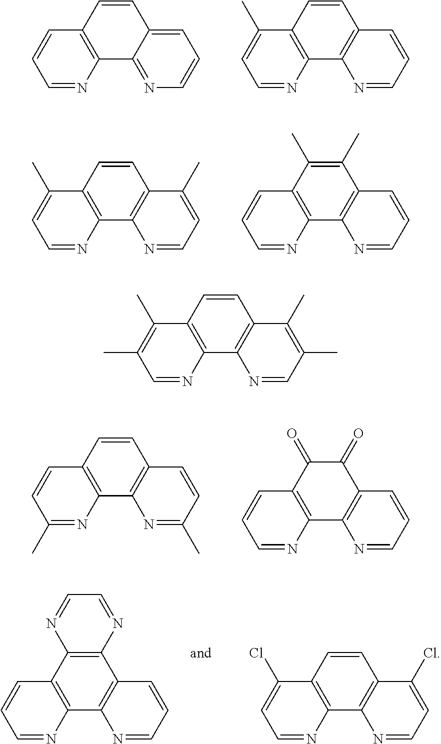

In certain embodiments, the ligand compound is selected from the group consisting of

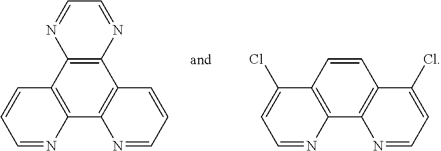 [SMILES: c1cnc2c(c1)c1nccnc1c1cccnc12 ; Clc1ccnc2c1ccc1c(Cl)ccnc12]

In certain embodiments, the ligand compound is selected from the group consisting of

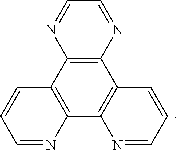 [SMILES: c1cnc2c(c1)c1nccnc1c1cccnc12]

In certain embodiments, the ligand compound is selected from the group consisting of

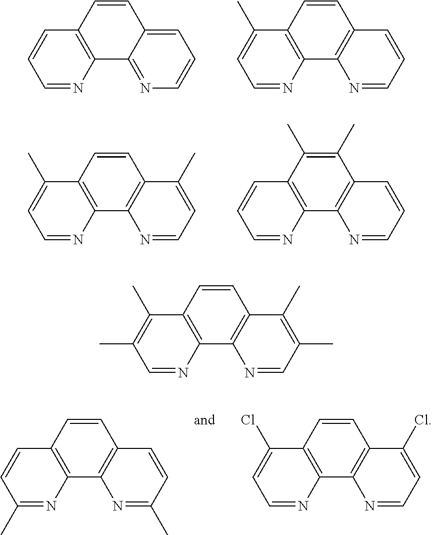

In certain embodiments, the ligand compound is selected from the group consisting of

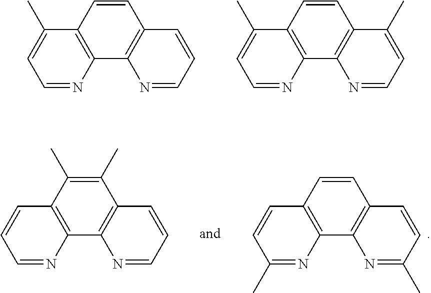

In certain embodiments, the ligand compound is

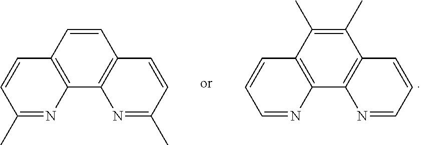 [SMILES: Cc1ccc2ccc3ccc(C)nc3c2n1 ; Cc1c(C)c2cccnc2c2ncccc12]

In certain embodiments, the ligand compound is

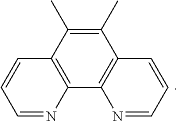 [SMILES: Cc1c(C)c2cccnc2c2ncccc12]

In certain embodiments, the composition comprises two or more ligands as described herein.

In certain embodiments, the zero-valent metal is Zn⁰. In certain embodiments, the zero-valent metal is Fe⁰. In certain embodiments, the zero-valent metal is Al⁰. In certain embodiments, the zero-valent metal is Ti⁰. In certain embodiments, the zero-valent metal is Mg⁰.

In certain embodiments, the zero-valent metal comprises, or can be provided as, metallic powders or grains.

In certain embodiments, the zero-valent metal comprises, or can be provided as, metallic particles (e.g., nanometer, micrometer, and/or millimeter-sized metallic particles of Zn (Zinc), Fe (iron), Al (aluminum), Ti (titanium), or Mg (magnesium)).

In certain embodiments, the zero-valent metal (e.g., Zn, Fe, Al, Ti, or Mg) comprises nanoparticles having size (e.g., averaged diameter) of less than 1000 nm, for example about 1-999 nm, 20-500 nm, or 40-60 nm. In certain embodiments, the zero-valent metal comprises nanoparticles having size (e.g., averaged diameter) of about 1, 5, 10, 20, 30, 40, 50, 60, 70, 80, 90, 100, 150, 200, 250, 300, 350, 400, 450, 500, 550, 600, 650, 700, 750, 800, 850, 900, or 950 nm. In certain embodiments, the zero-valent metal comprises nanoparticles having size (e.g., averaged diameter) of about 5-600, 1-500, 10-90, 20-80, 40-70, 60-80, 10-100, 20-150, 10-200, 20-250, 10-300, 20-350, 10-400, 20-450, 10-500, 20-600, 10-700, 20-800, or 10-900 nm.

In certain embodiments, the zero-valent metal (e.g., Zn, Fe, Al, Ti, or Mg) comprises microparticles having size of less than 1 mm, for example about 1-999 μm). In certain embodiments, the zero-valent metal comprises microparticles having size (e.g., averaged diameter) of about 1, 5, 10, 20, 30, 40, 50, 60, 70, 80, 90, 100, 150, 200, 250, 300, 350, 400, 450, 500, 550, 600, 650, 700, 750, 800, 850, 900, or 950 μm. In certain embodiments, the zero-valent metal comprises microparticles having size (e.g., averaged diameter) of about 5-600, 1-500, 10-90, 20-80, 40-70, 60-80, 10-100, 20-150, 10-200, 20-250, 10-300, 20-350, 10-400, 20-450, 10-500, 20-600, 10-700, 20-800, or 10-900 μm.

In certain embodiments, the zero-valent metal (e.g., Zn, Fe, Al, Ti, or Mg) comprises particles having size of less than 1 cm, for example about 1-9.9 mm). In certain embodiments, the zero-valent metal comprises particles having size (e.g., averaged diameter) of about 1, 2, 3, 4, 5, 6, 7, 8, or 9 mm. In certain embodiments, the zero-valent metal comprises particles having size (e.g., averaged diameter) of about 1-9, 2-8, 3-7, 4-9, or 5-8 mm.

In certain embodiments, the ligand binds to the metal (Zn⁰, Fe⁰, Al⁰, Ti⁰, or Mg⁰) particle surface. In certain embodiments, the composition comprises ligand coordinated Zn⁰, Fe⁰, Al⁰, Ti⁰, or Mg⁰, such as a ligand coordinated or adsorbed on a metal particle surface.

In certain embodiments, the composition is a liquid composition (e.g., aqueous composition).

In certain embodiments, the composition comprises a ligand as described herein at a concentration of about 0.005-0.3, 0.005-0.25, 0.005-0.125, 0.01-0.12, 0.015-0.11, 0.02-0.1, 0.025-0.09, 0.03-0.08, or 0.025-0.25 mM. In certain embodiments, the composition comprises a ligand at a concentration of about 0.005, 0.01, 0.015, 0.02, 0.025, 0.03, 0.04, 0.05, 0.06, 0.07, 0.08, 0.09, 0.1, 0.125, 0.2, 0.25, or 0.3 mM. In certain embodiments, the composition comprises a ligand at a concentration of about 0.25 mM. In certain embodiments, the composition comprises a ligand at a concentration of about 0.025 mM.

In certain embodiments, the composition comprises metal (e.g., Zn⁰, Fe⁰, Al⁰, Ti⁰, or Mg⁰) grain or particle as described herein at a concentration of about 1-20, 2-18, 5-15, 5-10, 6-12, 10-16, 5-12.5, or 6-16 mg mL⁻¹. In certain embodiments, the composition comprises metal (e.g., Zn⁰, Fe⁰, Al⁰, Ti⁰, or Mg⁰) grain or particle as described herein at a concentration of about 1, 2, 3, 4, 5, 6, 7, 8, 9, 10, 11, 12, 13, 14, 15, 16, 17, 18, 19, or 20 mg mL⁻¹. In certain embodiments, the composition comprises metal (e.g., Zn⁰, Fe⁰, Al⁰, Ti⁰, or Mg⁰) grain or particle as described herein at a concentration of about 5, 10, or 12.5 mg mL⁻¹.

In certain embodiments, the composition has a pH≥7 (e.g., pH≥8, 9, 10, or 11). In certain embodiments, the composition has a pH of about 7. 7.5, 8, 8.5, 9, 9.5, 10, 10.5, 11, 11.5 or 12. In certain embodiments, the composition has a pH of about 7-12, 8-11, 8-10, 8-9, 7-9, 9-10, or 9-11.

In certain embodiments, the composition further comprises ammonium or borate based buffer component or salt. In certain embodiments, the composition further comprises ammonia/ammonium salt buffer component, such as NH₄Cl. In certain embodiments, the composition comprises ammonium salt (e.g., NH₄Cl, (NH₄)₂SO₄, or ammonium acetate) at a concentration of about 1, 2, 3, 4, 5, 6, 7, 8, 9, 10, 11, 12, 13, 14, 15, or 16 mM. In certain embodiments, the composition comprises ammonium salt (e.g., NH₄Cl) at a concentration of about 1-16, 2-12, 3-11, 4-10, or 5-10 mM.

In certain embodiments, the composition is a solid composition (e.g., powder).

In certain embodiments, the composition further comprises a carrier (e.g., porous carrier, such as activated carbon, or porous silica). For example, the carrier media may be blended with the ligand-metal (e.g., ligand-zine, ligand-Fe, ligand-Al, ligand-Ti, or ligand-Mg) composite or serve as support for the ligand-metal composite.

Certain embodiments of the invention provide a method of making a composition as described herein, comprising mixing 1) a zero-valent metal selected from the group consisting of Zn, Fe, Al, Ti, and Mg (zinc, iron, aluminum, titanium, and magnesium); and 2) a ligand compound as described herein.

In certain embodiments, the mixing comprising mixing the zero-valent metal and the ligand compound in a liquid (e.g., an aqueous solution). In certain embodiments, the mixing comprising mixing the zero-valent metal at a concentration (e.g., 5-12.5 mg mL⁻¹) described herein with the ligand compound at a concentration (e.g., 0.025-0.25 mM) described herein.

In certain embodiments, the method further comprises adding ammonium salt (e.g., NH₄Cl), for example, to a concentration (e.g., 10 mM) as described herein. In certain embodiments, the method further comprises adjusting the pH of the composition to a pH as described herein (e.g., to pH 9).

In certain embodiments, the method further comprises adding a carrier (e.g., porous carrier, such as activated carbon, or porous silica) to the composition.

In certain embodiments, the method further comprises drying the liquid (e.g., the aqueous solution) to provide a concentrated liquid composition or a solid composition (e.g., powders).

Certain embodiments of the invention provide a device or system as described herein.

In certain embodiments, the device or system is a filtering device or system comprising a composite or composition described herein. For example, a compartment or chamber of the filtering device could be loaded with a composite material or composition as described herein. In certain embodiments, the composition further comprising a carrier such as activated carbon is loaded within a filtering device. In certain embodiments, the composite material or composition may be contained or sandwiched between permeable membranes or meshes. In certain embodiments, a filtering device or system further comprises one or more carrier material(s), such as sand, clay, carbon, resin, plastic beads, glass beads, or a mixture thereof. In certain embodiments, the carrier material(s) may facilitate the immobilization of the metal-ligand composite described herein and provide adequate water conductivity (i.e., allowing the water to penetrate at a desirable rate).

In certain embodiments, the device or system is a reactive barrier comprising a composite or composition described herein (e.g., permeable reactive barrier loaded with metallic particles and organic ligands described herein, which can be used for in situ PFAS groundwater remediation). In certain embodiments, the filtering device is a permeable reactive barrier.

Certain embodiments of the invention provide a method comprising contacting a PFAS compound with a composite, composition or a device or system as described herein.

In certain embodiments, the PFAS compound is a per- or polyfluoroalkyl compound of branched or unbranched, hydrocarbon chain having from 2 to 30 (e.g., 2-16, 7-15, or 8-14) carbon atoms, wherein one or more of the carbon atoms is optionally replaced by (—O—), wherein the hydrocarbon chain is substituted on carbon with one or more (e.g., two or more) substituents selected from the group consisting of halo (e.g., F, Cl, Br, and I), carboxyl, and SO₃. In certain embodiments, all C—H bonds of the compound are substituted with halo (e.g., all C—F bonds in the compound and no C—H bond). In certain embodiments, at least 90%, 80%, 70%, 60%, 50%, 40%, 30%, 20%, or 10% of all C—H bonds of the compound are substituted with halo (e.g., compound having a plurality of C—F bonds, C—Cl, C—Br, and/or C—I bonds).

In certain embodiments, the PFAS compound is a linear PFAS compound.

In certain embodiments, the PFAS compound is a branched PFAS compound.

In certain embodiments, the PFAS compound is a perfluorocarboxylate compound that has one terminal carboxyl group that is directly linked with the perfluoroalkyl chain.

In certain embodiments, the PFAS compound is a long-chain perfluorocarboxylate compound of CₙF₂ₙ₊₁—COO⁻, wherein n is ≥7 (e.g., n≥8).

In certain embodiments, the PFAS compound is a perfluoroether carboxylate compound (having one or more ether oxygen, such as 1, 2, or 3 —O—).

In certain embodiments, the PFAS compound is a chlorinated polyfluorocarboxylate compound.

In certain embodiments, the PFAS compound is a, branched or unbranched, per- or polyfluoroalkyl compound that comprises sulfonic acid group S(═O)₂OH, and wherein one or more of the carbon atoms is optionally replaced by (—O—) and the compound optionally further comprises carboxyl group. In certain embodiments, the PFAS compound is a perfluoroalkylsulfonate compound that has one terminal sulfonic acid group S(═O)₂OH that is directly linked with the perfluoroalkyl chain. For example, in certain embodiments, the PFAS compound is perfluorobutanesulfonic acid (PFBS). In certain embodiments, the PFAS compound is perfluorohexanesulfonic acid (PFHxS). In certain embodiments, the PFAS compound is perfluorooctanesulfonic acid (PFOS). In certain embodiments, the PFAS compound is a Nafion byproduct (e.g., Nafion byproduct-2, Nafion byproduct-5, or Nafion byproduct-6).

In certain embodiments, the PFAS compound is contacted at a pH≥7 (e.g., pH≥8, 9, 10, or 11). In certain embodiments, the PFAS compound is contacted at a pH of about 7. 7.5, 8, 8.5, 9, 9.5, 10, 10.5, 11, 11.5 or 12. In certain embodiments, the PFAS compound is contacted at a pH of about 7-12, 8-11, 8-10, 8-9, 7-9, 9-10, or 9-11.

In certain embodiments, the PFAS compound is contacted at a temperature of 10, 20, 30, 40, 50, 60, 70, 80, or 90° C. In certain embodiments, the PFAS compound is contacted at room temperature of about 20-25° C. In certain embodiments, the PFAS compound is contacted without heating. In certain embodiments, the PFAS compound is contacted under heating. In certain embodiments, the PFAS compound is contacted at a temperature of about 40-95, 50-95, 60-90, 70-90, 80-95, or 90-95° C.

In certain embodiments, the PFAS compound is contacted at a metal (e.g., Zn⁰, Fe⁰, Al⁰, Ti⁰, or Mg⁰) grain or particle concentration of about 1-20, 2-18, 5-15, 5-10, 6-12, 10-16, 5-12.5, or 6-16 mg mL⁻¹. In certain embodiments, the PFAS compound is contacted at a metal (e.g., Zn⁰, Fe⁰, Al⁰, Ti⁰, or Mg⁰) grain or particle concentration of about 1, 2, 3, 4, 5, 6, 7, 8, 9, 10, 11, 12, 13, 14, 15, 16, 17, 18, 19, or 20 mg mL⁻¹. In certain embodiments, the PFAS compound is contacted at a metal (e.g., Zn⁰, Fe⁰, Al⁰, Ti⁰, or Mg⁰) grain or particle concentration of about 5, 10, or 12.5 mg mL⁻¹.

In certain embodiments, the PFAS compound is contacted with a composite or composition described herein at a concentration of Zn⁰ particles of about 5-12.5 mg/mL.

In certain embodiments, the PFAS compound is contacted with a composite or composition described herein at a concentration of ligand of about 0.005-0.125 mM.

In certain embodiments, the PFAS compound is contacted at a ligand concentration of about 0.005-0.3, 0.005-0.25, 0.005-0.125, 0.01-0.12, 0.015-0.11, 0.02-0.1, 0.025-0.09, 0.03-0.08, or 0.025-0.25 mM. In certain embodiments, the PFAS compound is contacted at a ligand concentration of about 0.005, 0.01, 0.015, 0.02, 0.025, 0.03, 0.04, 0.05, 0.06, 0.07, 0.08, 0.09, 0.1, 0.125, 0.2, 0.25, or 0.3 mM. In certain embodiments, the PFAS compound is contacted at a ligand concentration of about 0.25 mM. In certain embodiments, the PFAS compound is contacted at a ligand concentration of about 0.025 mM.

In certain embodiments, the PFAS compound is contacted for about at least 1, 2, 3, 4, 5, 6, 7, 8, 9, 10, 12, 16, 20, 24, 36, 48 hours or longer. In certain embodiments, the PFAS compound is contacted for about at least 1-72, 2-48, 3-36, 4-24, 5-20, 6-18, 7-16, 8-12, or 9-10 hours.

In certain embodiments, the method does not comprise contacting the PFAS compound with CoCl₂. In certain embodiments, the method further comprises contacting the PFAS compound with CoCl₂.

In certain embodiments, the defluorination percentage (deF %) of a contacted PFAS compound is increased by at least 30%, 40%, 50%, 60%, 70%, 80%, 90%, 100%, 150%, 200% or more by a ligand coordinated metal described herein, as compared to a control, such as a control metal in the absence of the ligand.

In certain embodiments, the defluorination reaction is accelerated or the same defluorination percentage (deF %) of a contacted PFAS compound can be achieved in a time period that is at least 30%, 40%, 50%, 60%, 70%, 80%, or 90% shorter by a ligand coordinated metal described herein, as compared to a control, such as a control metal in the absence of the ligand.

Certain non-limiting, exemplary embodiments include:

Embodiment 1. A composite or composition as described herein.

Embodiment 2. A composite or composition comprising:
1) a zero-valent metal selected from the group consisting of Zn, Fe, Al, Ti, and Mg;
2) a ligand compound that is 2,2′-bipyridine optionally substituted with one or more substituent selected from the group consisting of (C₁-C₆)alkyl, (C₁-C₆)alkoxy, halo, amino, hydroxy, nitro, and CN.

Embodiment 3. The composite or composition of Embodiment 2, wherein the ligand compound has structure of

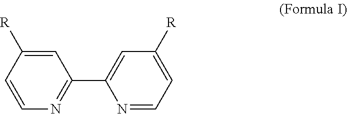

wherein each R is independently H, (C₁-C₆)alkyl, (C₁-C₆)alkoxy, halo, amino, hydroxy, nitro, or CN.

Embodiment 4. The composite or composition of Embodiment 2 or 3, wherein the zero-valent metal is Zn⁰.

Embodiment 5. The composite or composition of any one of Embodiments 2-4, wherein the zero-valent metal comprises nanoparticles (e.g., nZn⁰).

Embodiment 6. A device or system comprising the composite or composition of any one of Embodiments 1-5.

Embodiment 7. A method as described herein.

Embodiment 8. A method comprising contacting a PFAS compound with a composite or a composition or a device or a system as described herein.

Embodiment 9. The method of Embodiment 8, wherein the PFAS compound is a linear PFAS compound.

Embodiment 10. The method of Embodiment 8, wherein the PFAS compound is a branched PFAS compound.

Embodiment 11. The method of Embodiment 8, wherein the PFAS compound is a long-chain perfluorocarboxylate compound of CₙF₂ₙ₊₁—COO⁻, wherein n is ≥7 (e.g., n≥8).

Embodiment 12. The method of Embodiment 8, wherein the PFAS compound is a chlorinated polyfluorocarboxylate compound.

Embodiment 13. The method of Embodiment 8, wherein the PFAS compound is a perfluoroether carboxylate compound.

Certain non-limiting, advantageous features include, but not limited to, no need for external energy input (e.g., UV light or electricity), enhanced cost-effectiveness and less expensive than other methods using external energy input (in situ reaction), high efficacy in selectively treating long-chain PFAS, which cannot be removed by current pump-and-treat for groundwater remediation, unique application value for groundwater remediation, such as “permeable reactive barrier”, unique application value for wastewater treatment without using external energy, and easy system construction by blending the ligand-metal (e.g., ligand-zinc) composite with porous media/carrier, etc.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, (C₁-C₆)alkyl, (C₂-C₆)alkyl, (C₁-C₃)alkyl, and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and higher homologs and isomers.

The term “alkoxy” refers to the formula —OR or radical thereof, where R is an alkyl as defined.

The term “halo” or “halogen” refers to bromo, chloro, fluoro or iodo. In some embodiments, halogen refers to chloro or fluoro.

The term “cycloalkyl” or “carbocycle” refers to a saturated or partially unsaturated (non-aromatic) all carbon ring having 3 to 8 carbon atoms (i.e., (C₃-C₈)carbocycle). The term also includes multiple condensed, saturated all carbon ring systems (e.g., ring systems comprising 2, 3 or 4 carbocyclic rings). Accordingly, carbocycle includes multicyclic carbocyles such as a bicyclic carbocycles (e.g., bicyclic carbocycles having about 3 to 15 carbon atoms, about 6 to 15 carbon atoms, or 6 to 12 carbon atoms such as bicyclo[3.1.0]hexane and bicyclo[2.1.1]hexane), and polycyclic carbocycles (e.g tricyclic and tetracyclic carbocycles with up to about 20 carbon atoms). The rings of the multiple condensed ring system can be connected to each other via fused, spiro and bridged bonds when allowed by valency requirements. For example, multicyclic carbocyles can be connected to each other via a single carbon atom to form a spiro connection (e.g., spiropentane, spiro[4,5]decane, etc), via two adjacent carbon atoms to form a fused connection (e.g., carbocycles such as decahydronaphthalene, norsabinane, norcarane) or via two non-adjacent carbon atoms to form a bridged connection (e.g., norbornane, bicyclo[2.2.2]octane, etc). Non-limiting examples of cycloalkyls include cyclopropyl, cyclobutyl, cyclopentyl, cyclohexyl, bicyclo[2.2.1]heptane, pinane, and adamantane. In certain embodiments, the carbocycle is a C₆ carbocycle.

The term “aryl” as used herein refers to a single all carbon aromatic ring or a multiple condensed all carbon ring system wherein at least one of the rings is aromatic. For example, in certain embodiments, an aryl group has 6 to 20 carbon atoms, 6 to 14 carbon atoms, 6 to 12 carbon atoms, or 6 to 10 carbon atoms. Aryl includes a phenyl radical. Aryl also includes multiple condensed carbon ring systems (e.g., ring systems comprising 2, 3 or 4 rings) having about 9 to 20 carbon atoms in which at least one ring is aromatic and wherein the other rings may be aromatic or not aromatic (i.e., cycloalkyl). The rings of the multiple condensed ring system can be connected to each other via fused, spiro and bridged bonds when allowed by valency requirements. It is to be understood that the point of attachment of a multiple condensed ring system, as defined above, can be at any position of the ring system including an aromatic or a carbocycle portion of the ring. Non-limiting examples of aryl groups include, but are not limited to, phenyl, indenyl, indanyl, naphthyl, 1, 2, 3, 4-tetrahydronaphthyl, anthracenyl, and the like.

The term “heterocycle” or “heterocycloalkyl” refers to a single saturated or partially unsaturated ring that has at least one atom other than carbon in the ring, wherein the atom is selected from the group consisting of oxygen, nitrogen and sulfur; the term also includes multiple condensed ring systems that have at least one such saturated or partially unsaturated ring, which multiple condensed ring systems are further described below. Thus, the term includes single saturated or partially unsaturated rings (e.g., 3, 4, 5, 6 or 7-membered rings) from about 1 to 6 carbon atoms and from about 1 to 3 heteroatoms selected from the group consisting of oxygen, nitrogen and sulfur in the ring. The sulfur and nitrogen atoms may also be present in their oxidized forms. Exemplary heterocycles include but are not limited to azetidinyl, tetrahydrofuranyl and piperidinyl. The term “heterocycle” or “heterocycloalkyl” also includes multiple condensed ring systems (e.g., ring systems comprising 2, 3 or 4 rings) wherein a single heterocycle ring (as defined above) can be condensed with one or more groups selected from cycloalkyl, aryl, and heterocycle to form the multiple condensed ring system. The rings of the multiple condensed ring system can be connected to each other via fused, spiro and bridged bonds when allowed by valency requirements. It is to be understood that the individual rings of the multiple condensed ring system may be connected in any order relative to one another. It is also to be understood that the point of attachment of a multiple condensed ring system (as defined above for a heterocycle) can be at any position of the multiple condensed ring system including a heterocycle, aryl and carbocycle portion of the ring. In one embodiment the term heterocycle includes a 3-15 membered heterocycle. In one embodiment the term heterocycle includes a 3-10 membered heterocycle. In one embodiment the term heterocycle includes a 3-8 membered heterocycle. In one embodiment the term heterocycle includes a 3-7 membered heterocycle. In one embodiment the term heterocycle includes a 3-6 membered heterocycle. In one embodiment the term heterocycle includes a 4-6 membered heterocycle. In one embodiment the term heterocycle includes a 3-10 membered monocyclic or bicyclic heterocycle comprising 1 to 4 heteroatoms. In one embodiment the term heterocycle includes a 3-8 membered monocyclic or bicyclic heterocycle heterocycle comprising 1 to 3 heteroatoms. In one embodiment the term heterocycle includes a 3-6 membered monocyclic heterocycle comprising 1 to 2 heteroatoms. In one embodiment the term heterocycle includes a 4-6 membered monocyclic heterocycle comprising 1 to 2 heteroatoms. Exemplary heterocycles include, but are not limited to aziridinyl, azetidinyl, pyrrolidinyl, piperidinyl, homopiperidinyl, morpholinyl, thiomorpholinyl, piperazinyl, tetrahydrofuranyl, dihydrooxazolyl, tetrahydropyranyl, tetrahydrothiopyranyl, 1,2,3,4-tetrahydroquinolyl, benzoxazinyl, dihydrooxazolyl, chromanyl, 1,2-dihydropyridinyl, 2,3-dihydrobenzofuranyl, 1,3-benzodioxolyl, 1,4-benzodioxanyl, spiro[cyclopropane-1,1′-isoindolinyl]-3′-one, isoindolinyl-1-one, 2-oxa-6-azaspiro[3.3]heptanyl, imidazolidin-2-one imidazolidine, pyrazolidine, butyrolactam, valerolactam, imidazolidinone, hydantoin, dioxolane, phthalimide, and 1,4-dioxane.

The term “heteroaryl” as used herein refers to a single aromatic ring that has at least one atom other than carbon in the ring, wherein the atom is selected from the group consisting of oxygen, nitrogen and sulfur; “heteroaryl” also includes multiple condensed ring systems that have at least one such aromatic ring, which multiple condensed ring systems are further described below. Thus, “heteroaryl” includes single aromatic rings of from about 1 to 6 carbon atoms and about 1-4 heteroatoms selected from the group consisting of oxygen, nitrogen and sulfur. The sulfur and nitrogen atoms may also be present in an oxidized form provided the ring is aromatic. Exemplary heteroaryl ring systems include but are not limited to pyridyl, pyrimidinyl, oxazolyl or furyl. “Heteroaryl” also includes multiple condensed ring systems (e.g., ring systems comprising 2, 3 or 4 rings) wherein a heteroaryl group, as defined above, is condensed with one or more rings selected from cycloalkyl, aryl, heterocycle, and heteroaryl. It is to be understood that the point of attachment for a heteroaryl or heteroaryl multiple condensed ring system can be at any suitable atom of the heteroaryl or heteroaryl multiple condensed ring system including a carbon atom and a heteroatom (e.g., a nitrogen). Exemplary heteroaryls include but are not limited to pyridyl, pyrrolyl, pyrazinyl, pyrimidinyl, pyridazinyl, pyrazolyl, thienyl, indolyl, imidazolyl, triazolyl, tetrazolyl, oxazolyl, isoxazolyl, thiazolyl, furyl, oxadiazolyl, thiadiazolyl, quinolyl, isoquinolyl, benzothiazolyl, benzoxazolyl, indazolyl, quinoxalyl, and quinazolyl.

Certain non-limiting embodiments are further illustrated by the Example below:

### Example 1. Organic Ligand Enabled PFAS Defluorination by Metallic Zinc

This study explores the ligand-enabled reductive defluorination of per- and polyfluoroalkyl substances (PFAS) by metallic zinc. Adding a N,N-bidentate ligand, 4,4′-dimethyl-2,2′-bipyridine (Me₂bpy), to nano-sized zinc powder (nZn⁰) enabled rapid and significant defluorination from linear long-chain perfluorocarboxylates (CₙF₂ₙ₊₁—COO⁻) and perfluoroether carboxylates (CₓF₂ₓ₊₁—O—C_{y}F_{2y}—COO⁻) that did not degrade in the cobalt (e.g., vitamin B12)-catalyzed systems. The heterogeneous nature of reductive PFAS defluorination by nZn⁰ was confirmed by comparison among diverse PFAS substrates and with the homogeneous UV-sulfite system. The examined PFAS substrates include CₙF₂ₙ₊₁—COO⁻, ⁻OOC—CₙF₂ₙ—COO⁻, CₙF₂ₙ₊₁—CH₂CH₂—COO⁻, CₙF₂ₙ₊₁—SO₃⁻, CₓF₂ₓ₊₁—O—C_{y}F_{2y}—COO⁻, and Cl—(CF₂CFCl)ₙ—CF₂COO⁻ of various chain lengths and linear/branch patterns. The results provide mechanistic insights into designing and understanding heterogeneous reaction systems for PFAS degradation. This study also demonstrates the critical role of organic ligands in enhancing the reactivity of metallic nanoparticles for potential in situ PFAS remediation, highlighting the environmental significance of coordination chemistry.

### INTRODUCTION

The urgent demand for the degradation of per- and polyfluoroalkyl substances (PFAS) in the global water environment has led to flourishing technology innovations in the past two decades. The majority of engineering approaches use energetic inputs such as hydrothermal,¹⁻³ ultraviolet light,⁴⁻¹¹ plasma,¹²⁻¹⁵ electricity,¹⁶⁻¹⁹ ultrasonication,^{20,21} and even gamma ray²²⁻²⁴ to cleave the strong C—F bonds. In many systems, hydrated electrons, hydroxyl radicals, and semiconductor holes are the primary reactive species. However, PFAS destruction does not necessarily require “advanced” redox reactive species or reaction conditions. For example, using NaOH in water/DMSO mixed solvent achieved defluorination of perfluorocarboxylates (PFCAs, n=1-8 CₙF₂ₙ₊₁—COO⁻) and GenX (C₃F₇—O—CF(CF₃)—COO⁻) at 40-120° C.^{25, 26} “Traditional” chemical systems were generally considered ineffective for PFAS destruction, although might worth further re-investigation.

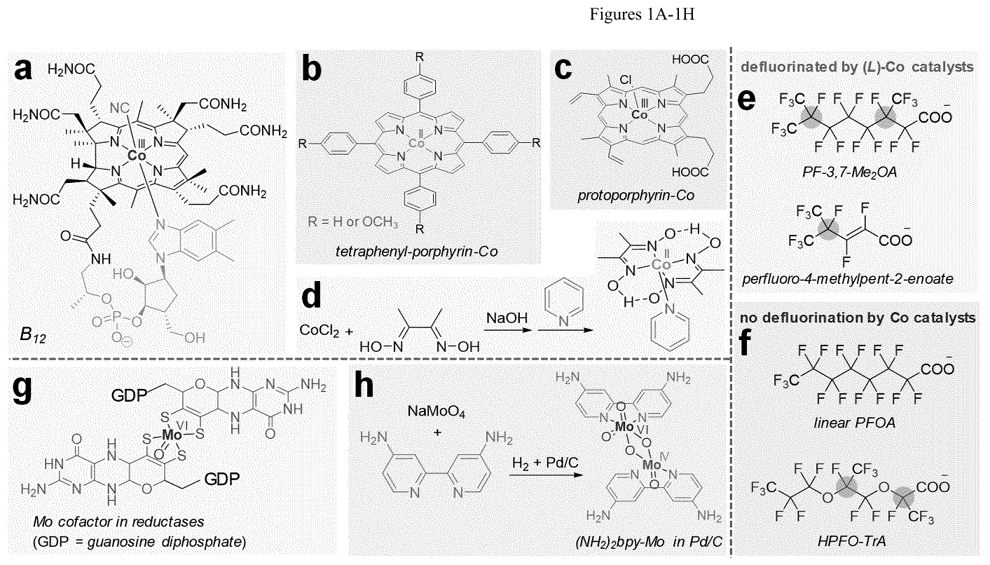

In 2008, Ochoa-Herrea et al.²⁷ reported B₁₂ (a corrin-Co^{III} complex, FIG. 1A)-catalyzed reductive defluorination of branched PFOS isomers by citrate-stabilized Ti^{III}. The investigation of Co complexes was further extended to various porphyrin-Co^{II/III} structures (FIGS. 1B and 1C).^{28, 29} The reducing agent was later switched to nanometer-sized zinc and iron particles (nZn⁰ and nFe⁰)³⁰ and sulfide.³¹ In studies using technical PFOS as the substrate, the branched isomers were the primary source of defluorination.^{27, 30-32} In our study, the Co-catalyzed systems defluorinated branched PFCAs (FIG. 1E) but not linear PFOA or branched hexafluoropropylene oligomer trimer acid (HFPO-TrA, FIG. 1F).²⁸ In 2018, Blotevogel et al.³³ developed a theoretical model and predicted the half-lives for the first reductive PFOA defluorination step by micrometer-sized Zn⁰ and Fe⁰ as 7.6 years and 520,000 years, respectively.

While the above results have persuaded engineering practices to adopt “advanced” reaction systems to degrade common PFAS pollutants, the biomimetic design might be an alternative route to overcoming kinetic barriers and obtaining novel functions.^{34, 35} Enzymatic metal complexes such as B₁₂, chlorophyll (chlorin-Mg), heme (porphyrin-Fe), and Mo cofactor (pyranopterin-dithiolate-Mo, FIG. 1G) exhibit distinct functions that aqueous Co²⁺, Mg²⁺, Fe²⁺, and Mo oxyanions do not have. However, using organic ligands to enhance metal-mediated pollutant degradation via either oxidative³⁶⁻⁴² or reductive⁴³⁻⁴⁸ mechanisms has been largely underdeveloped. Recently, we added bipyridine (R₂bpy, R=variable substitution groups such as —NH₂ or —CH₃) to an “inorganic” MoOₓ—Pd/C catalyst⁴⁹ to enable perchlorate (ClO₄) reduction.⁵⁰ Under the reducing environment by H₂+Pd/C, the (NH₂)₂bpy and Na₂MoO₄ assembled in situ into a highly active catalytic site (FIG. 1H). The (NH₂)₂bpy-MoOₓ—Pd/C catalyst treated multiple spikes of concentrated ClO₄ (10 g L⁻¹, which microbes could not tolerate) without deactivation,⁵¹ showing the important roles of coordination chemistry for water pollutant degradation.

Because the property tuning of anionic N,N,N,N-tetradentate ligands in Co complexes is challenging (e.g., limited locations for structural modification, tedious synthesis, and low solubility),⁵²⁻⁵⁴ we sought to yield similar functions of the porphyrin-Co complexes by mixing N,N-bidentate (R)₂bpy ligands with CoCl₂ (FIG. 1D).⁵⁵⁻⁵⁹ We used nZn⁰ as the reducing agent, a promising electron source for groundwater remediation⁶⁰⁻⁶² and a much “cleaner” reagent than citrate-Ti^{III} for lab research.^{30, 63} To our surprise, the control experiment without CoCl₂ showed the highest defluorination performance. The new system even worked for linear PFCAs, suggesting the novel function of using R₂bpy and nZn⁰ together. Hence, we optimized the reactivity and probed mechanisms of the ligand-enhanced “traditional” reduction system using metallic particles.

### Materials and Methods

Chemicals. The nano-sized Zn⁰ powder was purchased from SkySpring Nanomaterials (9920XH, 99.7%, 40-60 nm)³⁰ and used as received. Additional details of the R₂bpy ligands, PFAS substrates, inorganic chemicals, and the preparation of stock solutions are also provided in the Supporting Information (SI) section below.

Reactions. All reactions were conducted in an anaerobic glove bag (Coy Laboratories, 95% N₂ and 5% H₂). For a typical reaction, a 15 mL round-bottom flask was loaded with 10 mL of an aqueous suspension containing individual PFAS (0.1 mM), nZn⁰ (10 mg mL⁻¹), Me₂bpy (0.025 mM), and NH₄Cl buffer (10 mM, pH adjusted to 9.0). The flask was sealed with a rubber stopper (penetrated with a 22-gauge needle as the H₂ outlet) and heated with 240 rpm magnetic stirring at 90° C. in a silicone oil bath. At designated reaction times, 1 mL of the suspension was collected and centrifuged at 12000 rpm to obtain the clear aqueous phase for further analysis.

Sample Analyses. The fluoride ion (F⁻) was measured by an ion-selective electrode (ISE, Fisherbrand Accumet) with a Thermo Scientific Orion Versa Star Pro meter. Unlike Ti^{III}-citrate,²⁸ nZn⁰ did not interfere with the ISE measurement. Transformation products of selected PFAS were analyzed by liquid chromatography equipped with a high-resolution quadrupole orbitrap mass spectrometer (LC-HRMS/MS) (Q Exactive, Thermo Fisher Scientific) following established protocols.⁶⁴ Scanning transmission electron microscopy (STEM) characterization was conducted for both pristine and used nZn⁰. Further technical details are described in the SI.

### Results and Discussion

Ligand-Enhanced Zn⁰ Reduction System. In the beginning, we added H₂bpy to the mixture of CoCl₂ and nZn⁰ for the defluorination of perfluoro-3,7-dimethyloctanoic acid (PF-3,7-Me₂OA). The H₂bpy+CoCl₂+nZn⁰ combination yielded 2.4% of defluorination percentage (deF %), much lower than using corrin-Co and porphyrin-Co in the first 24 h (Table 1, entry 1 versus 11 and 12). However, the deF % by the control setting (H₂bpy+nZn⁰, no CoCl₂) surprisingly reached 36.6%. Further screening of various R₂bpy ligands confirmed superior performance by nZn⁰ without CoCl₂. The deF % by Me₂bpy+nZn⁰ (Table 1, entry 2) exceeded those by corrin-Co and porphyrin-Co. Interestingly, the effect of R₂bpy ligands did not follow the trend of Hammett constants of R (Table 1, entries 1, 2, and 5). Moreover, Cl₂bpy resulted in very similar deF % as H₂bpy (Table 1, entry 9 versus 1), probably due to the rapid reductive dechlorination by nZn⁰.⁶⁵ The nZn⁰ reduction of nitro group⁶⁶ could also explain the similar deF % by using (NO₂)₂bpy and (NH₂)₂bpy (Table 1, entry 8 versus 6). In addition, mixing 1-3 equivalents of Me₂bpy with ZnCl₂ and citrate-Ti^{III} (as a potential bulk reductant) resulted in no defluorination.

TABLE 1
Defluorination of PF-3, 7-Me2OA by Various Reaction Systems.^{a}

| | ligand/catalyst | deF % after 24 h (%) | |
|---|---|---|---|
| entry | 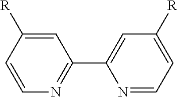 | nZn⁰ only | nZn⁰ + CoCl₂ |
| 1 | R = H | 36.6 ± 2.5 | 2.4 ± 0.1 |
| 2 | R = Me | 68.2 ± 3.1 | 5.6 ± 2.1 |
| | | (0.6% without nZn⁰) | |
| 3 | R = tBu | 28.0 ± 0.2 | 11.7 ± 0.5 |
| 4 | R = OH | 1.6 ± 0.4 | 1.0 ± 0.1 |
| 5 | R = OMe | 17.8 ± 2.0 | 2.6 ± 0.5 |
| 6 | R = NH₂ | 14.0 ± 0.3 | 1.5 ± 0.2 |
| 7 | R = CN | 43.1 ± 0.7 | 4.0 ± 0.1 |
| 8 | R = NO₂ | 14.1 ± 1.2 | 1.3 ± 0.3 |
| 9 | R = Cl | 33.6 ± 1.6 | 24.5 ± 0.8 |
| 10 | no ligand | 1.2 | 0.7 |

previous results (Ti^{III} citrate as the reductant, reaction conditions optimized)

| | | |
|---|---|---|
| 11 | B₁₂ (corrin-Co^{III}) | 31% |
| 12 | porphyrin-Co^{III} | 50% |

^{a}Reaction conditions: PF-3,7-Me₂OA (0.1 mM), nZn⁰ (5 mg/mL⁻¹), individual ligand (0.25 mM), NH₄Cl (10 mM), CoCl₂ (0.125 mM, if added), initial pH 9.0, and 70° C. Errors indicate the standard deviation of triplicate reactions.

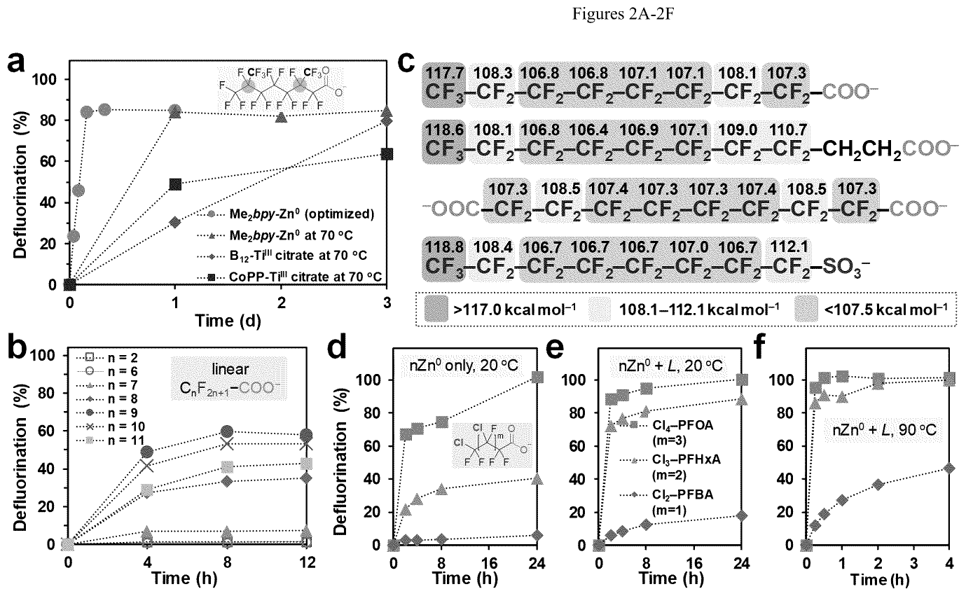

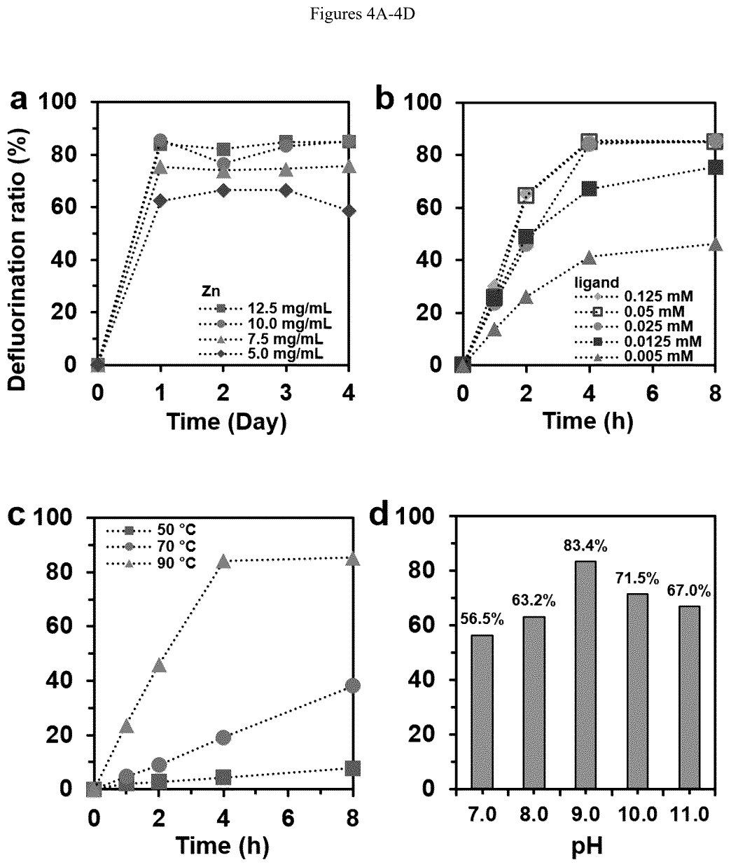

We used Me₂bpy to sequentially optimize the dose of nZn⁰ (10 mg mL⁻¹), the concentration of Me₂bpy (0.025 mM, one-tenth of the original level), temperature (90° C.), and pH (9.0) for the treatment of 0.1 mM PF-3,7-Me₂OA (FIG. 4). Under the optimized conditions, the parent compound was fully degraded, and the deF % reached 84% within 4 h (FIG. 2A), corresponding to the cleavage of 16 of the 19 C—F bonds in each PF-3,7-Me₂OA molecule. Hence, the Me₂bpy+nZn⁰ system outperformed the previous systems using Co complexes as catalysts.²⁸

The use of borate (pKₐ=9.23) as pH buffer yielded only 59% of defluorination, while those using ammonium buffers (pKₐ=9.25) with Cl⁻, SO₄²⁻, and CH₃COO⁻ counter anions reached 80-83%. Borate is known for passivating Zn solid surface.⁶⁷ The optimized loading of nZn⁰ (10 g L⁻¹, equivalent to 154 mM if “dissolved”) far exceeded PF-3,7-Me₂OA (0.1 mM). Hence, it appears that the reaction involved Zn⁰ below the outmost surface layer. Because nZn⁰ reacts with water and produces H₂, the reaction stoichiometry could not be established between dissolved Zn²⁺ and released F⁻. The ligand concentration (0.025 mM) is lower than the parent PF-3,7-Me₂OA (0.1 mM) and released F⁻ (up to 1.6 mM). Hence, the Me₂bpy ligand acted as a catalyst, whereas nZn⁰ served as the bulk reductant. The most probable reaction scheme is that Me₂bpy binds to a Zn⁰ atom on the particle surface (see below for the heterogeneous nature of the reaction) and facilitates the reductive C—F cleavage. The addition of CoCl₂ competed for the ligand, thus resulting in a much lower deF % (Table 1). However, the ligand/metal stoichiometry and the coordination structure of the Me₂bpy-Zn⁰ complex remain elusive. In addition, the -Me substitution was superior to both —H and —OMe, whereas —OH and —NH₂ allowed unexpectedly low defluorination. Therefore, the binding pattern for all R₂bpy ligands coordinating with the surface Zn⁰ is probably variable. The structure-activity relationship for the R₂bpy ligands is different from another Mo-catalyzed heterogeneous system for aqueous perchlorate reduction, where (NH₂)₂bpy outperformed all other ligands, including Me₂bpy.⁵⁰

Defluorination of Various PFAS by Me₂bpy-Zn⁰. In view of the high activity of Me₂bpy-Zn⁰ in PF-3,7-Me₂OA defluorination, we examined the reactivity with linear perfluorocarboxylates (PFCAs), which did not degrade in either Co—Zn⁰ or Co—Ti^{III} systems.^{28, 30} Surprisingly, PFOA (C₇F₁₅—COO⁻) showed 6.9% of defluorination within 4 h (FIG. 2B). Further extension of the substrate scope to longer (n=8-11) and shorter (n=2,6) CₙF₂ₙ₊₁—COO⁻ found a dependence on the fluoroalkyl chain length (Table 2, entries 1-8). Up to 60% of defluorination was achieved from long-chain linear PFCAs containing 17 to 23 C—F bonds, corresponding to the cleavage of 6 to 11 C—F bonds from the parent structures. In contrast, short-chain PFCAs showed negligible defluorination.

TABLE 2
Defluorination of various PFAS by the Me₂bpy-Zn⁰ Systems.^{a}

| | | | | |
|---|---|---|---|---|
| | | abbreviated | | # of F⁻ released |
| entry | PFAS structure | name | deF % at 8 h | per molecule |

perfluorocarboxylate [PFCA]

| | | | | |
|---|---|---|---|---|
| 1 | C₂F₅—COO⁻ | PFPrA | 1.6% | 0.1/5 |
| 2 | C₆F₁₃—COO⁻ | PFHpA | 1.3% | 0.2/13 |
| 3 | C₇F₁₅—COO⁻ | PFOA | 6.9% | 1.0/15 |
| 4 | C₈F₁₇—COO⁻ | PFNA | 33% | 5.7/17 |
| 5 | C₉F₁₉—COO⁻ | PFDA | 60% | 11.3/19 |
| 6 | 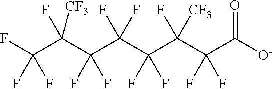 [SMILES: O=C([O-])C(F)(F)C(F)(C(F)(F)F)C(F)(F)C(F)(F)C(F)(F)C(F)(C(F)(F)F)C(F)(F)F] | PF-3,7-Me₂OA | 85% | 16.2/19 |
| 7 | C₁₀F₂₁—COO⁻ | PFUdA | 53% | 11.2/21 |
| 8 | C₁₁F₂₃—COO⁻ | PFDdA | 41% | 9.4/23 |

fluorotelomer carboxylate [FTCA]

| | | | | |
|---|---|---|---|---|
| 9 | C₄F₉—CH₂CH₂—COO⁻ | 4:3 FTCA | 0.2% | 0.0/9 |
| 10 | C₆F₁₃—CH₂CH₂—COO⁻ | 6:3 FTCA | 0.6% | 0.1/13 |
| 11 | C₈F₁₇—CH₂CH₂—COO⁻ | 8:3 FTCA | 0.5% | 0.1/17 |

Perfluoroalkane sulfonate [PFSA]

| | | | | |
|---|---|---|---|---|
| 12 | C₄F₉—SO₃⁻ | PFBS | 1.5% | 0.1/9 |
| 13 | C₆F₁₃—SO₃⁻ | PFHxS | 4.7% | 0.6/13 |
| 14 | C₈F₁₇—SO₃⁻ | PFOS | 9.1% | 1.5/17 |

perfluorodicarboxylate [PFdiCA]

| | | | | |
|---|---|---|---|---|
| 15 | ⁻OOC—C₆F₁₂—COO⁻ | — | 4.6% | 0.6/12 |
| 16 | ⁻OOC—C₈F₁₆—COO⁻ | — | 7.7% | 1.2/16 |

perfluoroether carboxylate [PFECA]
hexafluoropropylene oxide oligomer acid [HFPO-XA], branched

| | | | | |
|---|---|---|---|---|
| 17 | 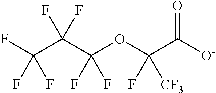 | HFPO-DA (GenX) | 0.3% | 0.0/9 |
| 18 | 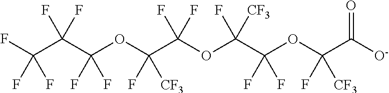 | HFPO-TeA | 12% | 2.7/23 |

linear

| | | | | |
|---|---|---|---|---|
| 19 | 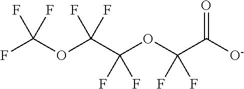 | “1 + 2 + 2″ | 6.7% | 0.6/9 |
| 20 | 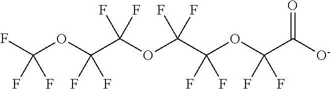 | “1 + 2 + 2 + 2″ | 26% | 3.4/13 |

chlorinated polyfluorocarboxylate [Clₓ—PFCA]

| | | | | |
|---|---|---|---|---|
| 21 | 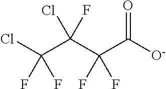 | Cl₂—PFBA | 55%, 80%, 92% at 8 h, 24 h, 48 h^{b} | 4.6/5 (48 h) |
| 22 | 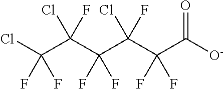 | Cl₃—PFHxA | 86%, 100% at 15 min, 4 h^{b} | 8/8 |
| 23 | 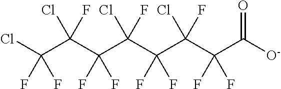 | Cl₄—PFOA | 96%, 101% at 15 min, 30 min^{b} | 11/11 |

^{a}Reaction conditions: individual PFAS (0.1 mM), nZn⁰ powder (10 mg/mL⁻¹), Me₂bpy (0.025 mM), NH₄Cl (10 mM), initial pH 9.0, 90° C., 8 h.
^{b}Time profiles at both 90° C. and 20° C. are shown in FIG. 2.

We hypothesized that the long fluoroalkyl chain (containing weak C—F bonds, FIG. 2C) was a contributing factor for defluorination. Hence, we further tested three fluorotelomer carboxylates (FTCAs, CₙF₂ₙ₊₁—CH₂CH₂—COO⁻, Table 2, entries 9-11). However, even the longest n=8 FTCA (FIG. 2C) did not allow defluorination. Notably, C₈F₁₇—CH₂CH₂—COO⁻ have the same number of total carbon as C₁₀F₂₁—COO⁻ (Table 2, entry 11 versus 7) and the same number of fluorinated carbon as C₈F₁₇—COO⁻ (Table 2, entry 11 versus 4). Therefore, the molecular reactivity might be influenced by the direct link between the fluoroalkyl chain and the carboxylate group. The three perfluoroalkane sulfonates (PFSAs, CₙF₂ₙ₊₁—SO₃⁻) showed slightly higher deF % than FTCAs. While we could not rule out the possibility of defluorination from branched isomers in PFSA reagents,³⁰ the largely different deF % from C₈F₁₇—SO₃ and C₈F₁₇—COO⁻ (Table 2, entry 14 versus 4) suggest the important role of the carboxylate group. The general trend of much higher reactivity of PFCAs than PFSAs and FTCAs is similar to that observed in a homogeneous reaction system, which used hydrated electrons generated from sulfite under 254 nm UV irradiation.⁶⁸

However, the hydrophobicity of PFAS might be another contributing factor. When the terminal CF₃ in C₉F₁₉—COO⁻ was replaced by another carboxylate (—COO—C₈F₁₆—COO PFdiCA, FIG. 2C), the deF % was significantly lowered (Table 2, entry 16 versus 5). In contrast, in the homogeneous UV/sulfite system, PFdiCAs allowed faster and higher deF % than PFCAs.^{64,68} Hence, the reduced hydrophobicity of PFdiCAs is the most probable cause for the diminished deF % by Me₂bpy-Zn⁰. We further examined four perfluoroethercarboxylates (PFECAs) with varying linear/branch patterns and chain lengths (Table 2, entries 17-20). The results corroborate the role of the carboxylate group and the dependence on the chain length. In particular, the branched, longer, and more hydrophobic hexafluoropropylene oxide tetramer acid (HFPO-TeA) showed a lower deF % than the linear, shorter, and less hydrophobic structure (Table 2, entry 18 versus 20). Therefore, the degradability of the former is inferior to the latter, similar to the trend observed for PFECA defluorination in the homogeneous UV/sulfite system.⁶⁹

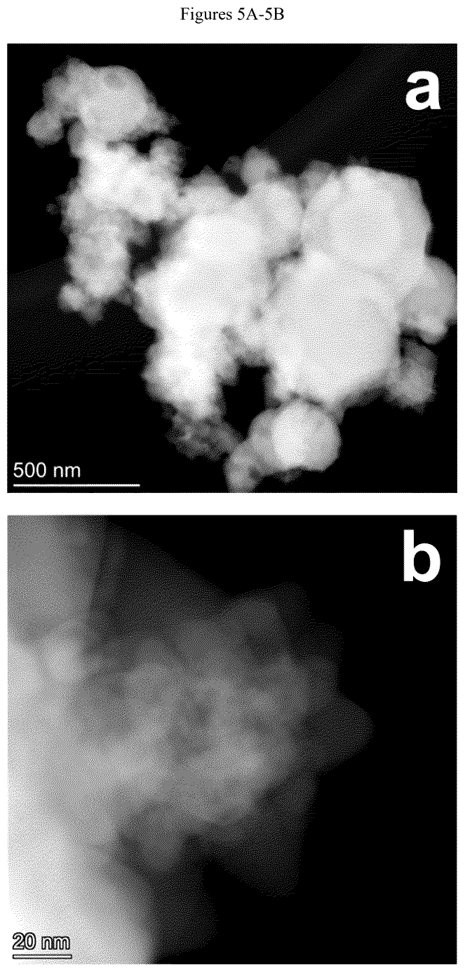

An earlier study found that the chlorinated polyfluorocarboxylate, Cl₄-PFOA (structure shown in Table 2, entry 23), could react with acid-treated 30-mesh (<600 μm) Zn⁰ grains at room temperature and release up to four F from each Cl₄-PFOA molecule in 5 days.³³ We used nZn⁰ powder (20-500 nm, FIG. 5) at 20° C. and achieved 100% defluorination within 24 h (FIG. 2D). As expected, the shorter-chain Cl₃-PFHxA and Cl₂-PFBA yielded lower deF %. Adding Me₂bpy not only accelerated the defluorination from Cl₄-PFOA, but also allowed deeper defluorination from Cl₃-PFHxA and Cl₂-PFBA (FIG. 2E). Elevating the temperature to 90° C. still could not achieve 100% defluorination from Cl₂-PFBA (FIG. 2F). Because the bond dissociation energies of C—F and C—Cl are similar among the three Clₓ—PFCAs,⁷⁰ the difference in reactivity is most likely attributed to mass transfer, further consolidating the heterogeneous nature of the Me₂bpy-Zn⁰ system.

In addition to the bipyridine ligands, certain triple-ring ligands, such as 1,10-Phenanthroline ligands, were also investigated (see Table 3) in this Example 1, and showed similar or superior performance as compared to Me₂bpy.

TABLE 3
Defluorination of linear PFDA (C₉F₁₉—COO⁻) by various triple-ring ligands
in comparison to 4,4′-dimethyl-2,2′-bipyridine.^{a}

| entry | ligand/catralyst | deF % after 4 h (%) |
|---|---|---|
| 1 | 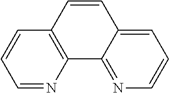 [SMILES: c1cnc2c(c1)ccc1cccnc12] | 9.5 |
| 2 | 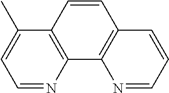 | 24.5 |
| 3 | 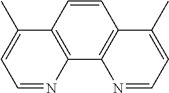 [SMILES: Cc1ccnc2c1ccc1c(C)ccnc12] | 56.0 |
| 4 | 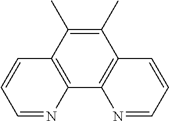 [SMILES: Cc1c(C)c2cccnc2c2ncccc12] | 24.1 |
| 5 | 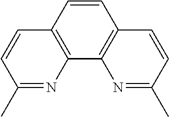 [SMILES: Cc1ccc2ccc3ccc(C)nc3c2n1] | 32.3 |
| 6 | 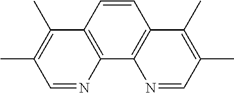 | 10.7 |
| 7 | 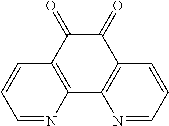 [SMILES: O=C1C(=O)c2cccnc2-c2ncccc21] | 1.2 |
| 8 | 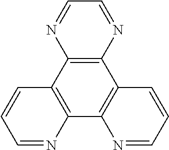 [SMILES: c1cnc2c(c1)c1nccnc1c1cccnc12] | 5.8 |
| 9 | 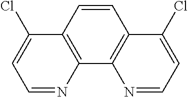 [SMILES: Clc1ccnc2c1ccc1c(Cl)ccnc12] | 7.9 |
| 10 | 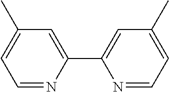 | 26.0^{b} |

^{a}Reaction conditions: PFDA (0.1 mM), nZn⁰ powder (10 mg mL⁻¹), individual ligand (0.025 mM), NH₄Cl (10 mM), initial pH 9.0, 90° C., 4 h.
^{b}The deF % value is less than earlier results due to the aging and slow oxidation of the same batch of nZn⁰ powder. However, all data in this table 3 were produced in the same batch, so direct comparison among these ligands is valid. Significantly higher deF % values are expected with freshly made nZn⁰ powder in the same or different sizes.

Mechanistic Insights. Beyond confirming the heterogeneous nature of the reaction system, our current experimental approaches cannot probe more detailed information at the molecular level.

Nevertheless, the outstanding performance by Me₂bpy among various R₂bpy ligands (without following the trend of Hammett constants) may indicate the complexity of the R₂bpy-Zn coordination pattern. Moreover, the primary role of Me₂bpy is likely not to enhance the mass transfer of PFAS to the nZn⁰ surface. First, the initial probe, PF-3,7-Me₂PFOA, is a highly hydrophobic structure and thus strongly favors aggregation at the heterogeneous interface. But the control experiment without ligand yielded negligible defluorination (Table 1, entry 10). In comparison, Cl₄-PFOA was completely defluorinated at the nZn⁰ surface without Me₂bpy. Second, adding octadecyltrimethylammonium chloride (C₁₈TMAC), a cationic surfactant used for enhancing the mass transfer of “high-solubility” anionic PFAS to the reactive water-gas interface,⁷¹ did not increase the deF % of PFOA by Me₂bpy-Zn⁰ (5.3%, versus 6.9% without C₁₈TMAC).

In earlier studies on B₁₂-catalyzed dechlorination of sp³ C—Cl bonds in CCl₄ and ClCH₂CN, mechanisms with various differences in subtle details were proposed. In general, (L)Co¹ could attack the C—Cl bond and yield (L)Co^{III}—C and Cl⁻.⁷² When (L)Co^{II} was the catalytic center, the single electron transfer converted the C—Cl into a C· radical and Cl⁻.^{73, 74} Because Zn^{II} is not reductive and Zn¹ is rare,⁷⁵ the most probable reaction species is Me₂bpy-coordinated Zn⁰. However, C₈F₁₇—COO⁻, C₈F₁₇—CH₂CH₂—COO⁻, and C₈F₁₇—SO₃ all contain weak C—F bonds (FIG. 2C) but exhibit very different reactivities (Table 2, entries 4, 11, and 14). Thus, the selective attack of weak C—F by Zn⁰ (i.e., forming Zn^{II}—C bonds at specific positions) is less likely. Instead, we propose that two electrons were directly transferred from Me₂bpy-Zn⁰ to the adsorbed PFAS molecule. Our preliminary analysis of transformation products from C₉F₁₉—COO⁻ found two H/F exchange intermediates (C₉F₁₈H—COO⁻ and C₉F₁₆H₃—COO⁻) and one chain-shortened intermediate (C₈F₁₇—COO⁻). These products suggest similar reaction pathways found in the homogeneous UV/sulfite system that generates hydrated electrons (e_{aq}⁻):

C—F+2e_{aq}⁻+H⁺→C—H+F⁻ (1)

C—F+[ligand-Zn⁰]+H⁺→C—H+F⁻+[ligand-Zn²⁺] (2)

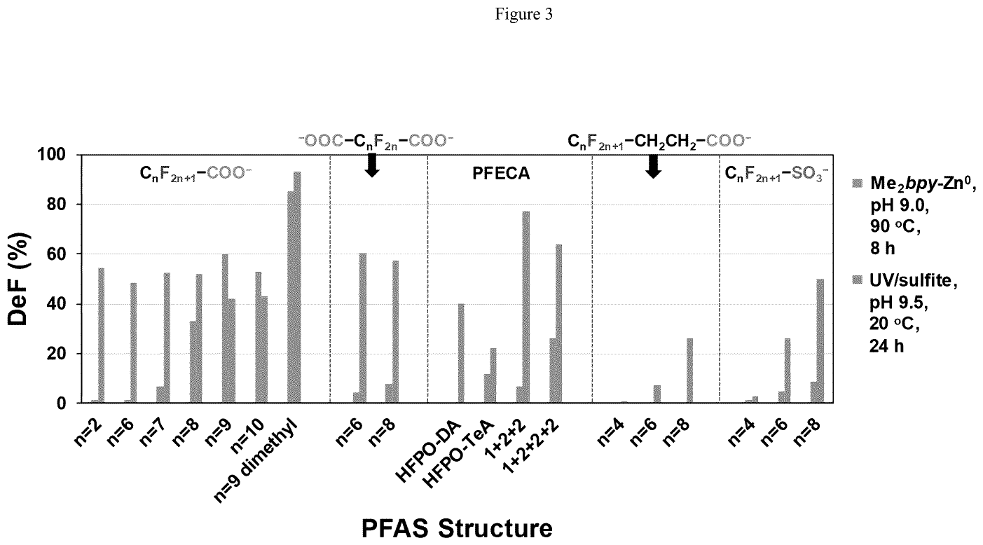

Further comparison of deF % values for various PFAS by Me₂bpy-Zn⁰ and UV/sulfite^{68, 69} also found high similarities for the long-chain PFAS (FIG. 3). At this moment, the mechanistic discussion could not go further because the “reductive defluorination” processes have not been well understood, such as how the chain-shortening occurred via a reductive process.⁷⁶ In addition, how the Me₂bpy ligand facilitates electron transfer from Zn⁰ to PFAS remains elusive and warrants further investigation.

Implications for Environmental Remediation. The Me₂bpy ligand surprisingly led to reductive defluorination from linear PFCAs and PFECAs by nZn⁰. Together with the smaller metallic particles and elevated temperature, the addition of Me₂bpy shortened the half-life of “the first reductive defluorination step for PFOA” from the model-predicted 7 years³³ to the experimentally observed 4 hours. The current Me₂bpy-Zn⁰ system may not fully satisfy all the requirements of PFAS degradation in certain polluted water samples, particularly for (i) limited reactivity toward short-chain PFAS and (ii) limited reactivity toward PFSAs and FTCAs. Extension of the PFAS substrate scope is urgent for many recently reported technologies that only demonstrated the efficacy toward PFOA. For the ligand-nZn⁰ system, we emphasize the high promise of coordination chemistry to further enhance intrinsic reactivity (and other approaches to enhance mass transfer of short-chain PFAS).

The use of Zn⁰ for environmental remediation has been explored for chlorinated organic pollutants.^{33,60-62} This study shows that specific organic ligands could add or enhance the reactivity of Zn⁰ with fluorinated chemicals. The current “selectivity” toward long-chain PFAS has a significant value for in situ groundwater or soil remediation. Long-chain PFAS are highly hydrophobic, strongly bind to soil organics, and thus cannot be effectively cleaned via the ex situ pump-and-treat strategy.^{77, 78} In multiple surface soil samples of the U.S. East Coast region, the n=8-11 CₙF₂ₙ₊₁—COO took more than 50% of the total PFCAs.⁷⁹ Chlorine-containing PFAS, which have much higher reactivity with Zn⁰ than perfluorinated counterparts, have also been confirmed as widespread soil pollutants.⁸⁰⁻⁸² Hence, a reactive barrier loaded with metallic particles and organic ligands may be a viable technical solution for in situ PFAS remediation.

### Supporting Information

### PFAS Chemicals.

PFAS chemicals were purchased from Oakwood Chemicals (OC), Apollo Scientific (AS), Manchester Organics (MO), and SynQuest Laboratories (SQ). Table A1 summarizes the name, purity, and CAS number.

TABLE A1
PFAS chemicals tested in this study.
Stock Solution Preparation

| | | | | |
|---|---|---|---|---|
| | | Number of | | |
| | | Fluorinated | | |
| Entry | Chemical Name | Carbons | Purity | CAS# |

Cl(CF₂)ₙ—COOH (or sodium salt)

| | | | | |
|---|---|---|---|---|
| 1 | sodium chlorodifluoroacetate | 1 | 97% | 1895-39-2 |
| 2 | 3-chlorotetrafluoropropionic acid | 2 | 97% | 661-82-5 |
| 3 | 5-chlorooctafluoropentanoic acid | 4 | N/A | 66443-79-6 |
| 4 | 9-chlorohexadecafluorononanoic acid | 8 | 97% | 865-79-2 |

ClCF₂(CFClCF₂)ₙ—COOH

| | | | | |
|---|---|---|---|---|
| 5 | 3,4-dichloropentafluorobutyric acid | 4 | 97% | 375-07-5 |
| 6 | 3,5,6-trichlorooctafluorohexanoic acid | 6 | 95% | 2106-54-9 |
| 7 | 3,5,7,8-tetrachloroperfluorooctanoic acid | 8 | 95% | 2923-68-4 |

special structures

| | | | | |
|---|---|---|---|---|
| 8 | potassium 9-chlorohexadecafluoro-3-oxanonane-1-sulfonate | 6:2 ether | 97% | 73606-19-6 |
| 9 | perfluoro(2-ethoxyethane)sulfonic acid | 2:2 ether | 97% | 113507-82-7 |
| 10 | 2-(fluorosulfonyl)difluoroacetic acid | 1 | 98% | 1717-59-5 |

Stock solutions were prepared with degassed solvents in an anaerobic glove bag (95% N₂ and 5% H₂ atmosphere; Coy Laboratories). PFASs were dissolved in methanol as 15 mM stock solutions. Substituted 2,2′-bipyridine ligands were dissolved in ethanol as 5 mM stock solutions. CoCl₂ was dissolved in DI water as 5 mM stock solution. Ammonia-ammonium buffer was prepared by dissolving 107.0 mg NH₄Cl in a 200 mL DI water, followed by adding 0.1 M NaOH solution until the pH reached 9.0.

### LC-HRMS Analysis.

All samples were diluted by 10 times and centrifuged at 12000 rpm before dilution for MS analysis.

### STEM Analysis.

Zn particles after reaction were filtered by DI water, and dried at 90° C. in the glove bag before the characterization by a scanning transmission electron microscope (STEM, FEI Titan Themis 300) equipped with an energy dispersive X-ray spectrometer (EDS) system at 300 kV accelerating voltage. STEM images were acquired with a high-angle annular dark-field (HAADF) detector.

Our attempts found that energy-dispersive X-ray (EDX) elemental analysis might be unsuitable for characterizing either Me₂bpy or PFAS adsorbed on the nZn⁰ surface. The thin organic layer could emit negligible signal compared to the bulk non-porous Zn particles.

### REFERENCES IN EXAMPLE 1

1. Hori, H.; Nagaoka, Y.; Murayama, M.; Kutsuna, S., Efficient decomposition of perfluorocarboxylic acids and alternative fluorochemical surfactants in hot water. Environmental Science & Technology 2008, 42, 7438-7443.
2. Wu, B.; Hao, S.; Choi, Y.; Higgins, C. P.; Deeb, R.; Strathmann, T. J., Rapid destruction and defluorination of perfluorooctanesulfonate by alkaline hydrothermal reaction. Environmental science & technology letters 2019, 6, 630-636.
3. Hao, S.; Choi, Y.-J.; Wu, B.; Higgins, C. P.; Deeb, R.; Strathmann, T. J., Hydrothermal alkaline treatment for destruction of per- and polyfluoroalkyl substances in aqueous film-forming foam. Environmental Science & Technology 2021, 55, 3283-3295.
4. Hori, H.; Hayakawa, E.; Einaga, H.; Kutsuna, S.; Koike, K.; Ibusuki, T.; Kiatagawa, H.; Arakawa, R., Decomposition of environmentally persistent perfluorooctanoic acid in water by photochemical approaches. Environmental science & technology 2004, 38, 6118-6124.
5. Huang, L.; Dong, W.; Hou, H., Investigation of the reactivity of hydrated electron toward perfluorinated carboxylates by laser flash photolysis. Chemical Physics Letters 2007, 436, 124-128.
6. Park, H.; Vecitis, C. D.; Cheng, J.; Choi, W.; Mader, B. T.; Hoffmann, M. R., Reductive defluorination of aqueous perfluorinated alkyl surfactants: Effects of ionic headgroup and chain length. The Journal of Physical Chemistry A 2009, 113, 690-696.
7. Li, X.; Ma, J.; Liu, G.; Fang, J.; Yue, S.; Guan, Y.; Chen, L.; Liu, X., Efficient reductive dechlorination of monochloroacetic acid by sulfite/UV process. Environmental science & technology 2012, 46, 7342-7349.
8. Liu, Z.; Chen, Z.; Gao, J.; Yu, Y.; Men, Y.; Gu, C.; Liu, J., Accelerated Degradation of Perfluorosulfonates and Perfluorocarboxylates by UV/Sulfite+Iodide: Reaction Mechanisms and System Efficiencies. Environmental Science & Technology 2022, 56, 3699-3709.
9. Liu, Z.; Bentel, M. J.; Yu, Y.; Ren, C.; Gao, J.; Pulikkal, V. F.; Sun, M.; Men, Y.; Liu, J., Near-Quantitative Defluorination of Perfluorinated and Fluorotelomer Carboxylates and Sulfonates with Integrated Oxidation and Reduction. Environmental Science & Technology 2021.
10. Hori, H.; Yamamoto, A.; Hayakawa, E.; Taniyasu, S.; Yamashita, N.; Kutsuna, S.; Kiatagawa, H.; Arakawa, R., Efficient decomposition of environmentally persistent perfluorocarboxylic acids by use of persulfate as a photochemical oxidant. Environmental Science & Technology 2005, 39, 2383-2388.
11. Qanbarzadeh, M.; Wang, D.; Ateia, M.; Sahu, S. P.; Cates, E. L., Impacts of Reactor Configuration, Degradation Mechanisms, and Water Matrices on Perfluorocarboxylic Acid Treatment Efficiency by the UV/Bi3O(OH)(PO4)2 Photocatalytic Process. ACS ES & T Engineering 2020.
12. Stratton, G. R.; Dai, F.; Bellona, C. L.; Holsen, T. M.; Dickenson, E. R.; Mededovic Thagard, S., Plasma-based water treatment: efficient transformation of perfluoroalkyl substances in prepared solutions and contaminated groundwater. Environmental science & technology 2017, 51, 1643-1648.
13. Saleem, M.; Biondo, O.; Sretenovid, G.; Tomei, G.; Magarotto, M.; Pavarin, D.; Marotta, E.; Paradisi, C., Comparative performance assessment of plasma reactors for the treatment of PFOA; reactor design, kinetics, mineralization and energy yield. Chemical Engineering Journal 2020, 382, 123031.
14. Singh, R. K.; Multari, N.; Nau-Hix, C.; Woodard, S.; Nickelsen, M.; Mededovic Thagard, S.; Holsen, T. M., Removal of Poly- and Per-Fluorinated Compounds from Ion Exchange Regenerant Still Bottom Samples in a Plasma Reactor. Environmental Science & Technology 2020, 54, 13973-13980.
15. Singh, R. K.; Brown, E.; Thagard, S. M.; Holsen, T. M., Treatment of PFAS-containing landfill leachate using an enhanced contact plasma reactor. Journal of Hazardous Materials 2021, 408, 124452.
16. Niu, J.; Lin, H.; Gong, C.; Sun, X., Theoretical and experimental insights into the electrochemical mineralization mechanism of perfluorooctanoic acid. Environmental science & technology 2013, 47, 14341-14349.
17. Yang, S.; Fernando, S.; Holsen, T. M.; Yang, Y., Inhibition of perchlorate formation during the electrochemical oxidation of perfluoroalkyl acid in groundwater. Environmental Science & Technology Letters 2019, 6, 775-780.
18. Huang, D.; Wang, K.; Niu, J.; Chu, C.; Weon, S.; Zhu, Q.; Lu, J.; Stavitski, E.; Kim, J.-H., Amorphous Pd-Loaded Ti4O7 Electrode for Direct Anodic Destruction of Perfluorooctanoic Acid. Environmental Science & Technology 2020, 54, 10954-10963.
19. Radjenovic, J.; Duinslaeger, N.; Avval, S. S.; Chaplin, B. P., Facing the challenge of poly- and perfluoroalkyl substances in water: is electrochemical oxidation the answer?Environmental Science & Technology 2020, 54, 14815-14829.
20. Sidnell, T.; Wood, R. J.; Hurst, J.; Lee, J.; Bussemaker, M. J., Sonolysis of Per- And Poly Fluoroalkyl Substances (PFAS): A meta-analysis. Ultrasonics sonochemistry 2022, 105944.
21. Vecitis, C. D.; Park, H.; Cheng, J.; Mader, B. T.; Hoffmann, M. R., Kinetics and mechanism of the sonolytic conversion of the aqueous perfluorinated surfactants, perfluorooctanoate (PFOA), and perfluorooctane sulfonate (PFOS) into inorganic products. The Journal of Physical Chemistry A 2008, 112, 4261-4270.
22. Zhang, Z.; Chen, J.-J.; Lyu, X.-J.; Yin, H.; Sheng, G.-P., Complete mineralization of perfluorooctanoic acid (PFOA) by 7-irradiation in aqueous solution. Scientific reports 2014, 4, 1-6.
23. Trojanowicz, M.; Bartosiewicz, I.; Bojanowska-Czajka, A.; Kulisa, K.; Szreder, T.; Bobrowski, K.; Nichipor, H.; Garcia-Reyes, J. F.; Nalȩcz-Jawecki, G.; Mȩczyńska-Wielgosz, S., Application of ionizing radiation in decomposition of perfluorooctanoate (PFOA) in waters. Chemical Engineering Journal 2019, 357, 698-714.
24. Trojanowicz, M.; Bartosiewicz, I.; Bojanowska-Czajka, A.; Szreder, T.; Bobrowski, K.; Nalȩcz-Jawecki, G.; Mȩczyńska-Wielgosz, S.; Nichipor, H., Application of ionizing radiation in decomposition of perfluorooctane sulfonate (PFOS) in aqueous solutions. Chemical Engineering Journal 2020, 379, 122303.
25. Trang, B.; Li, Y.; Xue, X.-S.; Ateia, M.; Houk, K.; Dichtel, W. R., Low-temperature mineralization of perfluorocarboxylic acids. Science 2022, 377, 839-845.
26. Zhang, C.; McElroy, A. C.; Liberatore, H. K.; Alexander, N. L. M.; Knappe, D. R., Stability of Per- and Polyfluoroalkyl Substances in Solvents Relevant to Environmental and Toxicological Analysis. Environmental Science & Technology 2021.
27. Ochoa-Herrera, V.; Sierra-Alvarez, R.; Somogyi, A.; Jacobsen, N. E.; Wysocki, V. H.; Field, J. A., Reductive defluorination of perfluorooctane sulfonate. Environmental Science & Technology 2008, 42, 3260-3264.
28. Liu, J.; Van Hoomissen, D. J.; Liu, T.; Maizel, A.; Huo, X.; Fernández, S. R.; Ren, C.; Xiao, X.; Fang, Y.; Schaefer, C. E., Reductive defluorination of branched per- and polyfluoroalkyl substances with cobalt complex catalysts. Environmental Science & Technology Letters 2018, 5, 289-294.
29. Sun, J.; Jennepalli, S.; Lee, M.; Jones, A.; O'Carroll, D. M.; Manefield, M. J.; Bhadbhade, M.; Akermark, B. r.; Das, B.; Kumar, N., Efficient Reductive Defluorination of Branched PFOS by Metal-Porphyrin Complexes. Environmental Science & Technology 2022.
30. Park, S.; de Perre, C.; Lee, L. S., Alternate reductants with VB12 to transform C8 and C6 perfluoroalkyl sulfonates: Limitations and insights into isomer-specific transformation rates, products and pathways. Environmental Science & Technology 2017, 51, 13869-13877.
31. Sun, Z.; Geng, D.; Zhang, C.; Chen, J.; Zhou, X.; Zhang, Y.; Zhou, Q.; Hoffmann, M. R., Vitamin B12 (CoII) initiates the reductive defluorination of branched perfluorooctane sulfonate (br-PFOS) in the presence of sulfide. Chemical Engineering Journal 2021, 423, 130149.
32. Li, F.; Yang, N.; Yang, Z.; Cao, W.; Zhou, Z.; Liao, X.; Sun, W.; Yuan, B., Biomimetic degradability of linear perfluorooctanesulfonate (L-PFOS): Degradation products and pathways. Chemosphere 2020, 259, 127502.
33. Blotevogel, J.; Giraud, R. J.; Borch, T., Reductive defluorination of perfluorooctanoic acid by zero-valent iron and zinc: A DFT-based kinetic model. Chemical Engineering Journal 2018, 335, 248-254.
34. Bullock, R. M.; Chen, J. G.; Gagliardi, L.; Chirik, P. J.; Farha, O. K.; Hendon, C. H.; Jones, C. W.; Keith, J. A.; Klosin, J.; Minteer, S. D., Using nature's blueprint to expand catalysis with Earth-abundant metals. Science 2020, 369, eabc3183.
35. Holm, R. H.; Solomon, E. I., Preface: biomimetic inorganic chemistry. Chemical Reviews 2004, 104, 347-348.
36. Jans, U.; Prasse, C.; von Gunten, U., Enhanced treatment of municipal wastewater effluents by Fe-Taml/H2O2: Efficiency of micropollutant abatement. Environmental Science & Technology 2021, 55, 3313-3321.
37. Collins, T. J., TAML oxidant activators: a new approach to the activation of hydrogen peroxide for environmentally significant problems. Accounts of chemical research 2002, 35, 782-790.
38. Collins, T. J.; Ryabov, A. D., Targeting of high-valent iron-TAML activators at hydrocarbons and beyond. Chemical reviews 2017, 117, 9140-9162.
39. Canals, M.; Gonzalez-Olmos, R.; Costas, M.; Company, A., Robust iron coordination complexes with N-based neutral ligands as efficient Fenton-like catalysts at neutral pH. Environmental science & technology 2013, 47, 9918-9927.
40. Ellis, W. C.; Tran, C. T.; Denardo, M. A.; Fischer, A.; Ryabov, A. D.; Collins, T. J., Design of more powerful iron-TAML peroxidase enzyme mimics. Journal of the American Chemical Society 2009, 131, 18052-18053.
41. Kundu, S.; Chanda, A.; Khetan, S. K.; Ryabov, A. D.; Collins, T. J., TAML activator/peroxide-catalyzed facile oxidative degradation of the persistent explosives trinitrotoluene and trinitrobenzene in micellar solutions. Environmental science & technology 2013, 47, 5319-5326.
42. Tang, L. L.; DeNardo, M. A.; Gayathri, C.; Gil, R. R.; Kanda, R.; Collins, T. J., TAML/H₂O₂ oxidative degradation of metaldehyde: pursuing better water treatment for the most persistent pollutants. Environmental Science & Technology 2016, 50, 5261-5268.
43. Huang, J.; Jones, A.; Waite, T. D.; Chen, Y.; Huang, X.; Rosso, K. M.; Kappler, A.; Mansor, M.; Tratnyek, P. G.; Zhang, H., Fe (II) redox chemistry in the environment. Chemical reviews 2021, 121, 8161-8233.
44. Hurley, K. D.; Zhang, Y.; Shapley, J. R., Ligand-Enhanced Reduction of Perchlorate in Water with Heterogeneous Re—Pd/C Catalysts. Journal of the American Chemical Society 2009, 131, 14172-14173.
45. Liu, J.; Choe, J. K.; Wang, Y.; Shapley, J. R.; Werth, C. J.; Strathmann, T. J., Bioinspired complex-nanoparticle hybrid catalyst system for aqueous perchlorate reduction: Rhenium speciation and its influence on catalyst activity. ACS Catalysis 2015, 5, 511-522.
46. Liu, J.; Chen, X.; Wang, Y.; Strathmann, T. J.; Werth, C. J., Mechanism and mitigation of the decomposition of an oxorhenium complex-based heterogeneous catalyst for perchlorate reduction in water. Environmental science & technology 2015, 49, 12932-12940.
47. Liu, J.; Su, X.; Han, M.; Wu, D.; Gray, D. L.; Shapley, J. R.; Werth, C. J.; Strathmann, T. J., Ligand design for isomer-selective oxorhenium (V) complex synthesis. Inorganic chemistry 2017, 56, 1757-1769.
48. Ren, C.; Liu, J., Bioinspired Catalytic Reduction of Aqueous Perchlorate by One Single-Metal Site with High Stability against Oxidative Deactivation. ACS Catalysis 2021, 11, 6715-6725.
49. Ren, C.; Yang, P.; Gao, J.; Huo, X.; Min, X.; Bi, E. Y.; Liu, Y.; Wang, Y.; Zhu, M.; Liu, J., Catalytic Reduction of Aqueous Chlorate With MoOx Immobilized on Pd/C. ACS Catalysis 2020, 10, 8201-8211.
50. Ren, C.; Yang, P.; Sun, J.; Bi, E. Y.; Gao, J.; Palmer, J.; Zhu, M.; Wu, Y.; Liu, J., A Bioinspired Molybdenum Catalyst for Aqueous Perchlorate Reduction. Journal of the American Chemical Society 2021, 143, 7891-7896.
51. Ren, C.; Bi, E. Y.; Gao, J.; Liu, J., Molybdenum-Catalyzed Perchlorate Reduction: Robustness, Challenges, and Solutions. ACS ES & T Engineering 2022, 2, 181-188.
52. Hiroto, S.; Miyake, Y.; Shinokubo, H., Synthesis and functionalization of porphyrins through organometallic methodologies. Chemical reviews 2017, 117, 2910-3043.
53. Marlier, E. E.; Ulrich, B. A.; McNeill, K., Synthesis and reactivity of an isolable cobalt (I) complex containing a β-diketiminate-based acyclic tetradentate ligand. Inorganic chemistry 2012, 51, 2079-2085.
54. Fritsch, J. M.; McNeill, K., Aqueous reductive dechlorination of chlorinated ethylenes with tetrakis (4-carboxyphenyl) porphyrin cobalt. Inorganic chemistry 2005, 44, 4852-4861.
55. Droghetti, F.; Lucarini, F.; Molinari, A.; Ruggi, A.; Natali, M., Recent findings and future directions in photosynthetic hydrogen evolution using polypyridine cobalt complexes. Dalton Transactions 2022.
56. He, W.; Fontmorin, J.-M.; Hapiot, P.; Soutrel, I.; Floner, D.; Fourcade, F.; Amrane, A.; Geneste, F., A new bipyridyl cobalt complex for reductive dechlorination of pesticides. Electrochimica Acta 2016, 207, 313-320.
57. Kliegman, S.; McNeill, K., Dechlorination of chloroethylenes by cob (I) alamin and cobalamin model complexes. Dalton Transactions 2008, 4191-4201.
58. McCauley, K. M.; Wilson, S. R.; Van der Donk, W. A., Synthesis and characterization of chlorinated alkenylcobaloximes to probe the mechanism of vitamin B12-catalyzed dechlorination of priority pollutants. Inorganic Chemistry 2002, 41, 393-404.
59. Margel, S.; Anson, F. C., Catalysis of the Electroreduction of Allyl Chloride by Cobalt 2, 2′-Bipyridine Complexes. Journal of The Electrochemical Society 1978, 125, 1232.
60. Roberts, A. L.; Totten, L. A.; Arnold, W. A.; Burris, D. R.; Campbell, T. J., Reductive elimination of chlorinated ethylenes by zero-valent metals. Environmental Science & Technology 1996, 30, 2654-2659.
61. Sarathy, V.; Salter, A. J.; Nurmi, J. T.; O'Brien Johnson, G.; Johnson, R. L.; Tratnyek, P. G., Degradation of 1, 2, 3-trichloropropane (TCP): hydrolysis, elimination, and reduction by iron and zinc. Environmental Science & Technology 2010, 44, 787-793.
62. Salter-Blanc, A. J.; Tratnyek, P. G., Effects of solution chemistry on the dechlorination of 1, 2, 3-trichloropropane by zero-valent zinc. Environmental science & technology 2011, 45, 4073-4079.
63. Zehnder, A. J.; Wuhrmann, K., Titanium (III) citrate as a nontoxic oxidation-reduction buffering system for the culture of obligate anaerobes. Science 1976, 194, 1165-1166.
64. Gao, J.; Liu, Z.; Bentel, M. J.; Yu, Y.; Men, Y.; Liu, J., Defluorination of Omega-Hydroperfluorocarboxylates (ω—HPFCAs): Distinct Reactivities from Perfluoro and Fluorotelomeric Carboxylates. Environmental Science & Technology 2021.
65. Arnold, W. A.; Roberts, A. L., Pathways of chlorinated ethylene and chlorinated acetylene reaction with Zn (0). Environmental Science & Technology 1998, 32, 3017-3025.
66. ROBERTSON, G. R.; EVANS, R. A., The formation of chloroaniline during reduction of nitrobenzene. The Journal of Organic Chemistry 1940, 5, 142-145.
67. Diomidis, N.; Celis, J.-P., Anodic film formation on zinc in alkaline electrolytes containing silicate and tetraborate ions. Journal of The Electrochemical Society 2007, 154, C711.
68. Bentel, M. J.; Yu, Y.; Xu, L.; Li, Z.; Wong, B. M.; Men, Y.; Liu, J., Defluorination of per- and polyfluoroalkyl substances (PFASs) with hydrated electrons: Structural dependence and implications to PFAS remediation and management. Environmental science & technology 2019, 53, 3718-3728.
69. Bentel, M. J.; Yu, Y.; Xu, L.; Kwon, H.; Li, Z.; Wong, B. M.; Men, Y.; Liu, J., Degradation of perfluoroalkyl ether carboxylic acids with hydrated electrons: Structure-reactivity relationships and environmental implications. Environmental science & technology 2020, 54, 2489-2499.
70. Gao, J.; Liu, Z.; Huang, J.; Liu, J., Degradation Pathways and Complete Defluorination of Chlorinated Polyfluoroalkyl Substances (Clₓ-PFAS). ChemRxiv 2022, 10.26434/chemrxiv-2022-ql20q.
71. Nau-Hix, C.; Multari, N.; Singh, R. K.; Richardson, S.; Kulkarni, P.; Anderson, R. H.; Holsen, T. M.; Mededovic Thagard, S., Field demonstration of a pilot-scale plasma reactor for the rapid removal of poly- and perfluoroalkyl substances in groundwater. ACS ES & T Water 2021, 1, 680-687.
72. Argüello, J. E.; Costentin, C.; Griveau, S.; Savéant, J.-M., Role of protonation and of axial ligands in the reductive dechlorination of alkyl chlorides by vitamin B12 complexes. Reductive cleavage of chloroacetonitrile by Co (I) cobalamins and cobinamides. Journal of the American Chemical Society 2005, 127, 5049-5055.
73. Assaf-Anid, N.; Hayes, K. F.; Vogel, T. M., Reduction dechlorination of carbon tetrachloride by cobalamin (II) in the presence of dithiothreitol: mechanistic study, effect of redox potential and pH. Environmental science & technology 1994, 28, 246-252.
74. Chiu, P.-C.; Reinhard, M., Transformation of carbon tetrachloride by reduced vitamin B12 in aqueous cysteine solution. Environmental science & technology 1996, 30, 1882-1889.
75. Resa, I.; Carmona, E.; Gutierrez-Puebla, E.; Monge, A., Decamethyldizincocene, a stable compound of Zn (I) with a Zn—Zn bond. Science 2004, 305, 1136-1138.
76. Bentel, M. J.; Liu, Z.; Yu, Y.; Gao, J.; Men, Y.; Liu, J., Enhanced degradation of perfluorocarboxylic acids (PFCAs) by UV/sulfite treatment: Reaction mechanisms and system efficiencies at pH 12. Environmental Science & Technology Letters 2020, 7, 351-357.
77. Nguyen, T. M. H.; Bräunig, J.; Thompson, K.; Thompson, J.; Kabiri, S.; Navarro, D. A.; Kookana, R. S.; Grimison, C.; Barnes, C. M.; Higgins, C. P., Influences of chemical properties, soil properties, and solution pH on soil-water partitioning coefficients of per- and polyfluoroalkyl substances (PFASs). Environmental science & technology 2020, 54, 15883-15892.
78. Maizel, A. C.; Shea, S.; Nickerson, A.; Schaefer, C.; Higgins, C. P., Release of per- and polyfluoroalkyl substances from aqueous film-forming foam impacted soils. Environmental Science & Technology 2021, 55, 14617-14627.
79. Rankin, K.; Mabury, S. A.; Jenkins, T. M.; Washington, J. W., A North American and global survey of perfluoroalkyl substances in surface soils: Distribution patterns and mode of occurrence. Chemosphere 2016, 161, 333-341.
80. Washington, J. W.; Rosal, C. G.; McCord, J. P.; Strynar, M. J.; Lindstrom, A. B.; Bergman, E. L.; Goodrow, S. M.; Tadesse, H. K.; Pilant, A. N.; Washington, B. J., Nontargeted mass-spectral detection of chloroperfluoropolyether carboxylates in New Jersey soils. Science 2020, 368, 1103-1107.
81. McCord, J. P.; Strynar, M. J.; Washington, J. W.; Bergman, E. L.; Goodrow, S. M., Emerging chlorinated polyfluorinated polyether compounds impacting the waters of southwestern New Jersey identified by use of nontargeted analysis. Environmental science & technology letters 2020, 7, 903-908.
82. Evich, M. G.; Davis, M.; Weber, E. J.; Tebes-Stevens, C.; Acrey, B.; Henderson, W. M.; Goodrow, S.; Bergman, E.; Washington, J. W., Environmental Fate of Cl-PFPECAs: Predicting the Formation of PFAS Transformation Products in New Jersey Soils. Environmental Science & Technology 2022.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A composition comprising:
1) a zero-valent metal selected from the group consisting of Zn, Fe, Al, Ti, and Mg; and
2) a ligand compound having structure of 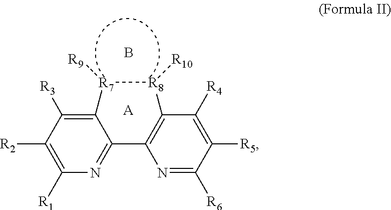
wherein R₁, R₂, R₃, R₄, R₅, and R₆ are each independently H, (C₁-C₆)alkyl, (C₁-C₆)alkoxy, halo, amino, hydroxy, nitro, or CN;
wherein R₇, and R₈ are each independently H, (C₁-C₆)alkyl, (C₁-C₆)alkoxy, halo, amino, hydroxy, nitro or CN, or R₇ and R₈ along with the intervening carbon atoms form a six membered carbocycle ring A;
wherein ring A is absent, or is the six membered carbocycle ring optionally substituted with R₉ and R₁₀, or is the six membered carbocycle ring fused with a six-membered heteroaryl ring B that is optionally substituted with one or more substituent selected from the group consisting of (C₁-C₆)alkyl, (C₁-C₆)alkoxy, halo, amino, hydroxy, nitro, and CN; and
wherein R₉, and R₁₀ are each independently absent, (C₁-C₆)alkyl, (C₁-C₆)alkoxy, halo, amino, hydroxy, nitro, oxo (═O), or CN.

2. The composition of claim 1, wherein the ligand compound has structure of

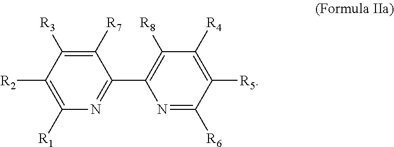

3. The composition of claim 1, wherein the ligand compound has structure of

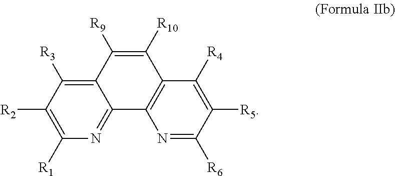

4. The composition of claim 1, wherein the ligand compound has structure of

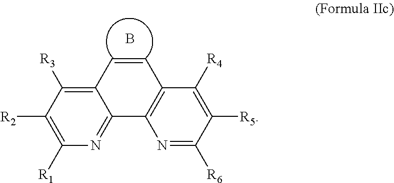

5. The composition of claim 1, wherein the ligand compound is 2,2′-bipyridine optionally substituted with one or more substituent selected from the group consisting of (C₁-C₆)alkyl, (C₁-C₆)alkoxy, halo, amino, hydroxy, nitro, and CN.

6. The composition of claim 5, wherein the ligand compound has structure of 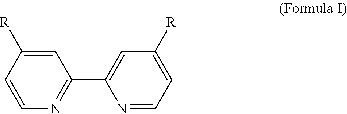
wherein each R is independently H, (C₁-C₆)alkyl, (C₁-C₆)alkoxy, halo, amino, hydroxy, nitro, or CN.

7. The composition of claim 1, wherein the ligand compound is selected from the group consisting of

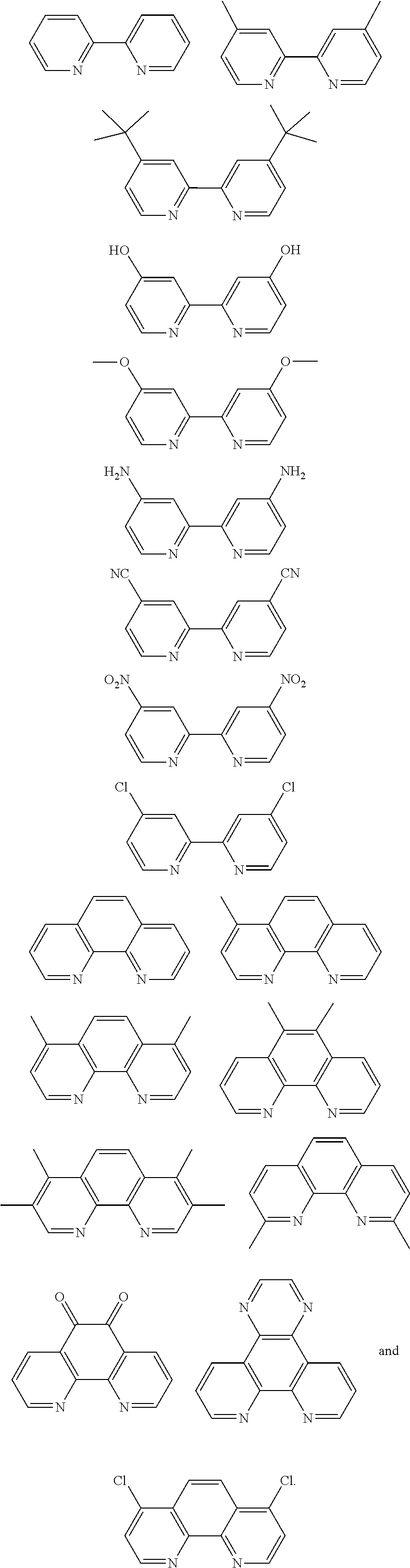

8. The composition of claim 6, wherein the ligand compound is selected from the group consisting of

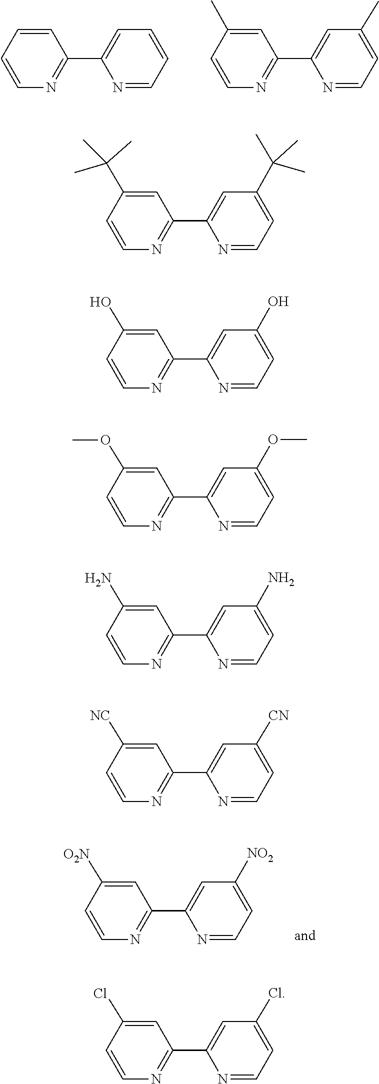

9. The composition of claim 8, wherein the ligand compound is selected from the group consisting of

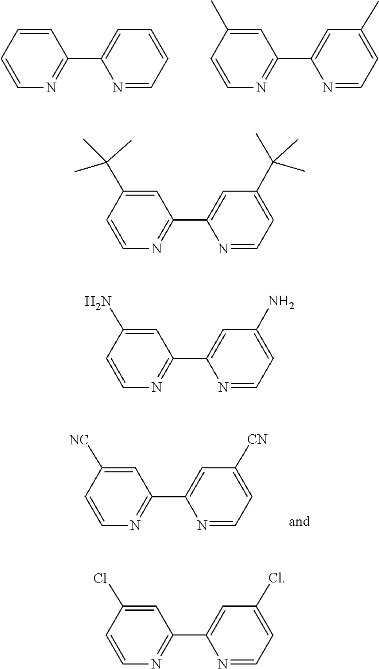

10. The composition of claim 9, wherein the ligand compound is

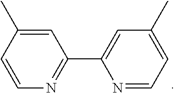

11. The composition of claim 1, wherein the ligand compound is selected from the group consisting of

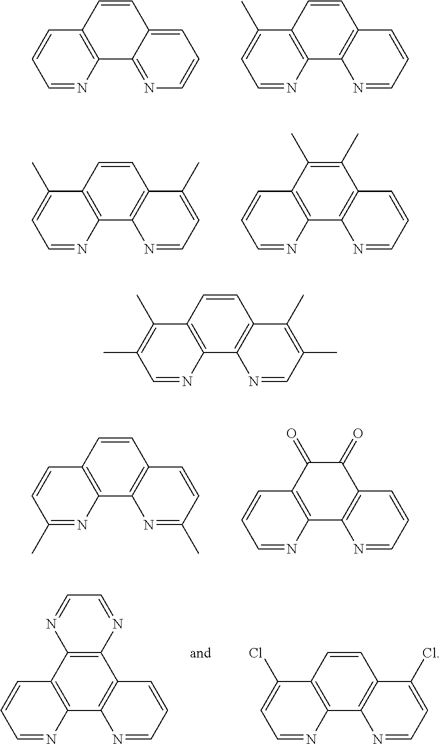

12. The composition of claim 3, wherein the ligand compound is selected from the group consisting of

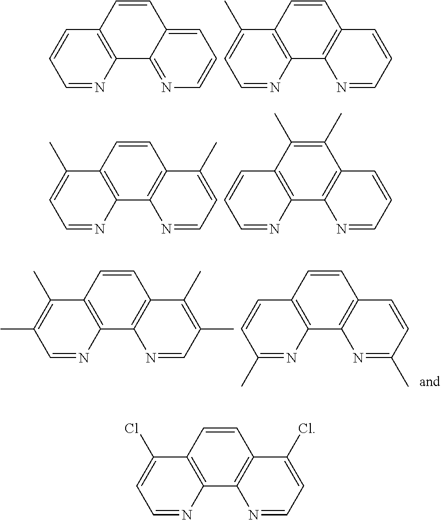

13. The composition claim 1, wherein the zero-valent metal comprises metal nanoparticles.

14. The composition of claim 13, wherein the zero-valent metal is Zn⁰.

15. The composition of claim 1, comprising the ligand at a concentration of about 0.025 to 0.25 mM.

16. The composition of claim 15, comprising the metal at a concentration of about 5 to 12.5 mg mL⁻¹.

17. The composition of claim 1, wherein the composition has a pH of about 8-9.

18. A filtering device comprising the composition of claim 1.

19. A method for making the composition of claim 1, comprising mixing the zero-valent metal selected from the group consisting of Zn, Fe, Al, Ti, and Mg, with the ligand compound of claim 1.

20. A method for degrading a PFAS compound, comprising contacting the PFAS compound with the composition of claim 1.
